(19) United States
(12) Patent Application Publication
(10) Pub. No.: US 2024/0153183 A1
(43) Pub. Date: May 9, 2024

(54) INFORMATION PROCESSING DEVICE, INFORMATION PROCESSING METHOD, AND PROGRAM

(71) Applicant: Sony Group Corporation, Tokyo (JP)

(72) Inventors: Jiro KAWANO, Tokyo (JP); Yoshihiro ASAKO, Tokyo (JP); Noriyuki KATO, Tokyo (JP)

(73) Assignee: Sony Group Corporation, Tokyo (JP)

(21) Appl. No.: 18/282,220

(22) PCT Filed: Mar. 26, 2021
(86) PCT No.: PCT/JP2021/012919

§ 371 Date: Sep. 15, 2023

(51) Int. Cl. G06T 13/40; G06T 17/00

(52) U.S. Cl. CPC G06T 13/40; G06T 17/00

(57) ABSTRACT

The present disclosure relates to an information processing device, an information processing method, and a program, by which a more realistic live stream of an event can be achieved.

A display control unit displays, on a terminal, a plurality of viewpoint images captured at different viewpoints in an event, and an avatar information acquisition unit acquires avatar information about display of avatars corresponding to each of a user who is viewing the plurality of viewpoint images displayed on the terminal and other users who are viewing the plurality of viewpoint images on other terminals. The display control unit controls the display of the avatars based on the avatar information, for the viewpoint images displayed on the terminal. The present technique is applicable to, for example, smartphones.

### TECHNICAL FIELD

The present disclosure relates to an information processing device, an information processing method, and a program, and more particularly, relates to an information processing device, an information processing method, and a program, by which a more realistic live stream of an event can be achieved.

### BACKGROUND ART

Conventionally, a technique of displaying an avatar as a character representing a user in a virtual reality space or an augmented reality space is available.

For example, PTL 1 discloses a video synthesis method, by which in a smartphone or the like, an avatar based on a user image captured by a front camera is superimposed on live video captured by a rear camera.

### CITATION LIST

### Patent Literature

[PTL 1]
JP 2020-87277A

### SUMMARY

### Technical Problem

In an event like sports viewing or a music festival, a user can participate the event from various points of view. In live-streaming service of such events, however, only an image captured from a single point of view is distributed.

The present disclosure has been devised in view of such circumstances. An object of the present disclosure is to attain a more realistic live stream of an event.

### Solution to Problem

An information processing device according to the present disclosure is an information processing device including: a display control unit that displays, on a terminal, a plurality of viewpoint images captured at different viewpoints in an event; and an avatar information acquisition unit that acquires avatar information about display of avatars corresponding to each of a user who is viewing the plurality of viewpoint images displayed on the terminal and other users who are viewing the plurality of viewpoint images on other terminals, wherein the display control unit controls the display of the avatars based on the avatar information, for the viewpoint images displayed on the terminal.

An information processing method according to the present disclosure is an information processing method causing an information processing device to: display, on a terminal, a plurality of viewpoint images captured at different viewpoints in an event; acquire avatar information about display of avatars corresponding to each of a user who is viewing the plurality of viewpoint images displayed on the terminal and other users who are viewing the plurality of viewpoint images on other terminals; and control the display of the avatars based on the avatar information, for the viewpoint images displayed on the terminal.

A program according to the present disclosure is a program causing a computer to execute processing of displaying, on a terminal, a plurality of viewpoint images captured at different viewpoints in an event; acquiring avatar information about display of avatars corresponding to each of a user who is viewing the plurality of viewpoint images displayed on the terminal and other users who are viewing the plurality of viewpoint images on other terminals; and controlling the display of the avatars based on the avatar information, for the viewpoint images displayed on the terminal.

The present disclosure displays, on a terminal, a plurality of viewpoint images captured at different viewpoints in an event, acquires avatar information about display of avatars corresponding to each of a user who is viewing the plurality of viewpoint images displayed on the terminal and other users who are viewing the plurality of viewpoint images on other terminals, and controls the display of the avatars based on the avatar information, for the viewpoint images displayed on the terminal.

### BRIEF DESCRIPTION OF DRAWINGS

FIG. 1 illustrates a configuration example of an image distribution system according to an embodiment of the present disclosure.

FIG. 2 is an explanatory drawing of the outline of image distribution in the image distribution system.

FIG. 3 illustrates a configuration example of an avatar.

FIG. 4 is a block diagram illustrating a functional configuration example of a server.

FIG. 5 illustrates a configuration example of event data.

FIG. 6 is a block diagram illustrating a functional configuration example of an imaging-side terminal.

FIG. 7 is a block diagram illustrating a functional configuration example of a viewing-side terminal.

FIG. 8 is an explanatory drawing of a flow of image distribution in the image distribution system.

FIG. 9 illustrates a display example of a viewpoint image in a panoramic mode.

FIG. 10 is an explanatory drawing of the layout of comments corresponding to the avatars.

FIG. 11 illustrates a display example of a self-avatar in the panoramic mode.

FIG. 12 illustrates a display example of a viewpoint image in a selection mode.

FIG. 13 is an explanatory drawing of a flow from participation in the event to the viewing of viewpoint images.

FIG. 14 is an explanatory drawing of a flow of avatar walking.

FIG. 15 illustrates an example of avatar walking.

FIG. 16 is an explanatory drawing of the layer configuration of a background image.

FIG. 17 illustrates an example of coordinate information about avatars.

FIG. 18 is an explanatory drawing of a flow of avatar action display.

FIG. 19 illustrates an example of avatar action display.

FIG. 20 is an explanatory drawing of a flow of avatar action display.

FIG. 21 illustrates an example of avatar action display.

FIG. 22 is an explanatory drawing of a flow of group creation and participation.

FIG. 23 illustrates an example of avatar preferential display.

FIG. 24 is an explanatory drawing of a flow of avatar preferential display.

FIG. 25 illustrates an example of avatar display linked with an event.

FIG. 26 illustrates an example of switching of avatar display.

FIG. 27 illustrates an example of an evaluation on a comment.

FIG. 28 illustrates a display example of viewpoint images on the imaging-side terminal.

FIG. 29 illustrates a display example of viewpoint images on the imaging-side terminal.

FIG. 30 illustrates a display example of objects.

FIG. 31 illustrates an example of a map view.

FIG. 32 is a block diagram illustrating a configuration example of a computer.

### DESCRIPTION OF EMBODIMENTS

Hereinafter, modes for carrying out the present disclosure (hereinafter referred as embodiments) will be described. The description will be made in the following order.
1. Outline of image distribution system
2. Functional configuration example of each device
3. Display mode of viewpoint image
4. Animation display of avatar
5. Preferential display of group and avatar
6. Other display variations
7. Configuration example of computer

<1. Outline of Image Distribution System>

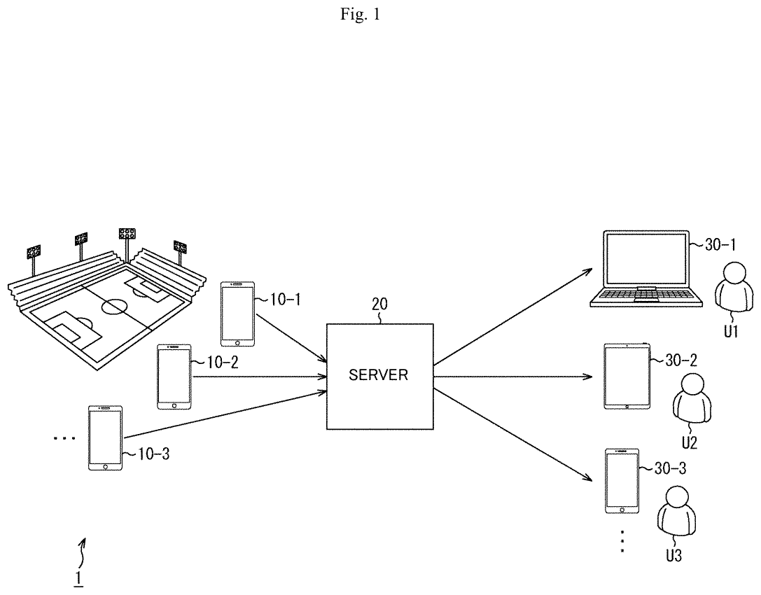

FIG. 1 illustrates the outline of an image distribution system according to an embodiment of the present disclosure.

As illustrated in FIG. 1, an image distribution system 1 is configured to include a plurality of imaging-side terminals 10-1, 10-2, 10-3, . . . , a server 20, and a plurality of viewing-side terminals 30-1, 30-2, 30-3, . . . .

The imaging-side terminals 10-1, 10-2, 10-3 . . . are operated by different users and are simply referred to as imaging-side terminals 10 when the terminals do not need to be distinguished from one another. Likewise, the viewing-side terminals 30-1, 30-2, 30-3 . . . are also operated by different users and are simply referred to as viewing-side terminals 30 when the terminals do not need to be distinguished from one another.

Connections between the imaging-side terminals 10 and the server 20 and connections between the server 20 and the viewing-side terminals 30 are made via the Internet.

The imaging-side terminals 10 capture viewpoint images from different viewpoints (angles) in an event like sports viewing or a music festival and then upload the images to the server 20. In the following example, a viewpoint image is captured at each point in a stadium during a soccer game.

The server 20 combines a plurality of viewpoint images uploaded by the imaging-side terminals 10 into one image. The server 20 then distributes the composite image to each of the viewing-side terminals 30. The server 20 may distribute the plurality of viewpoint images uploaded by the imaging-side terminals 10, as individual images to the respective viewing-side terminals 30.

Thus, from among viewpoint images captured from different viewpoints in an event, the imaging-side terminals 10-1, 10-2, 10-3 . . . and users U1, U2, U3, . . . can switch and view viewpoint images at desired angles at desired timings.

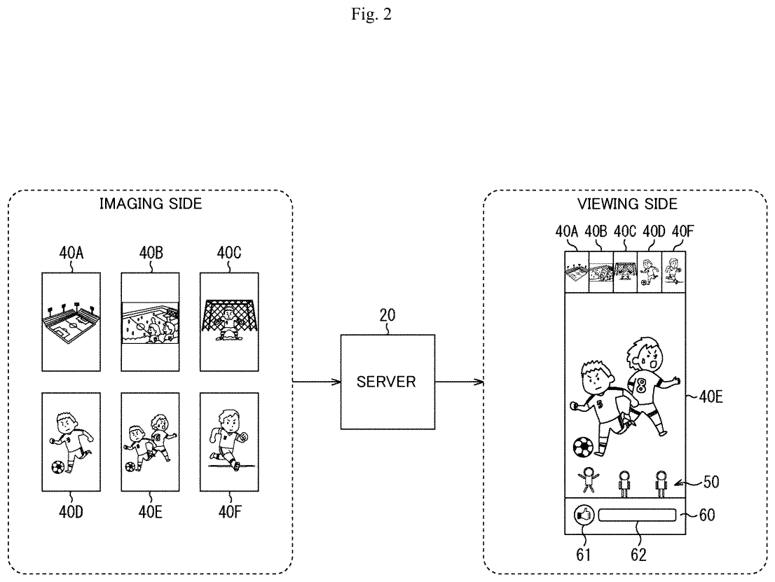

Referring to FIG. 2, the outline of image distribution in the image distribution system 1 will be described below.

On the imaging side in FIG. 2, six viewpoint images 40A to 40F are captured by the six imaging-side terminals 10. The viewpoint image 40A is a moving image of the overall stadium, and the viewpoint image 40B is a moving image in which spectators at seats serve as subjects. The viewpoint image 40C is a moving image in which a goal keeper serves as a subject, and the viewpoint image 40D is a moving image in which a dribbling player serves as a subject. The viewpoint image 40E is a moving image in which the dribbling player in the viewpoint image 40D and a player of the other team serve as subjects, and the viewpoint image 40F is a moving image in which another player of the same team as the dribbling player in the viewpoint image 40D serves as a subject.

The viewpoint images 40A to 40F are uploaded to the server 20 in real time and are distributed to the imaging side (imaging-side terminals 10) on the right side of FIG. 2.

On the imaging side (imaging-side terminals 10), the viewpoint images 40A to 40F are displayed together on one screen.

In the example of FIG. 2, from among the viewpoint images 40A to 40F, the viewpoint image 40E is largely displayed at the center of the screen while the other viewpoint images 40A to 40D and 40F of small size are displayed in line in the upper part of the screen. When one of the other viewpoint images 40A to 40D and 40F is selected by a viewer (user) from the state of FIG. 2, the selected viewpoint image (selected viewpoint image) is largely displayed at the center of the screen and the viewpoint image 40E of small size is displayed along with the other viewpoint images in the upper part of the screen.

In this way, in a display mode, one of the plurality of viewpoint images is selected and largely displayed on the screen of the viewing-side terminal 30. The display mode is referred to as a selection mode.

On the viewing-side terminal 30 (his/her own terminal) that displays a viewpoint image captured in an event, avatars 50 are displayed for each of a user (hereinafter referred to as a user) who is viewing the viewpoint image and users (hereinafter also referred to as other users) who are viewing the viewpoint image on the other viewing-side terminals 30 (other terminals).

In the example of FIG. 2, the three avatars 50 are displayed in the lower end part of the viewpoint image 40E displayed in the selection mode. Basically, the avatar 50 (hereinafter also referred to a self-avatar) corresponding to the user is always displayed at the center in the horizontal direction, whereas the avatars 50 (hereinafter also referred to as other avatars) corresponding to the other users are displayed at predetermined positions on the right or left of the self-avatar.

In the lower part of the screen in the selection mode, an evaluation area 60 is provided for inputting an evaluation of the viewpoint image displayed in the selection mode. Specifically, the evaluation area 60 includes a good button 61 that indicates a high rating for a viewpoint image displayed in the selection mode and a comment entry box 62 for a text input of a comment about the viewpoint image. A comment inputted to the comment entry box 62 is displayed as a balloon above the avatar 50 corresponding to the user having inputted the comment. The detail will be described later.

In this way, the users who are viewing the same viewpoint image can communicate with each other through evaluations of the viewpoint image by using the good button 61 and the comment entry box 62.

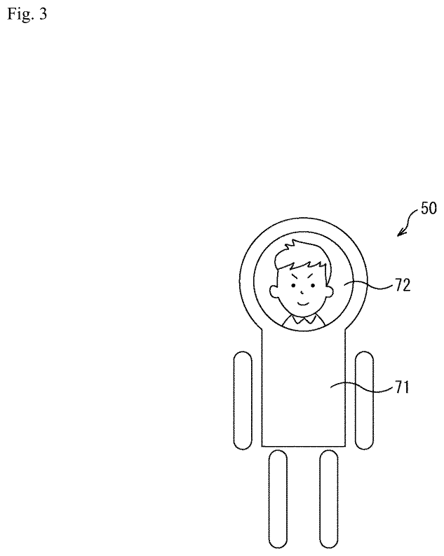

FIG. 3 illustrates a configuration example of the avatar 50.

As shown in FIG. 3, the avatars 50 is configured with a body 71 that is an image of a human body and an icon 72 that is synthesized to a part corresponding to the head of the body 71.

The motion of the body 71 is controlled in response to an operation performed on the viewing-side terminal 30 by a user corresponding to the avatar 50. For example, in response to a user operation, an animation of the walking body 71 or the body 71 high-flying with the avatar 50 of another user is displayed. The body 71 may be colored to distinguish the self-avatar from other avatars or may be designed for an event in which a viewpoint image is captured.

The icon 72 is, for example, a face image that allows identification of a user corresponding to the avatar 50. A face image applied to the icon 72 is a still image. For example, if video calling is available between users who are viewing the same viewpoint image, a moving image may be used instead. The icon 72 is not limited to a face image if the icon 72 is an image specific for the user corresponding to the avatar 50.

Thus, the display and motions of the avatars 50 allow users who are viewing the same viewpoint image to more intuitively communicate with each other.

A specific configuration for distributing a plurality of viewpoint images in the image distribution system 1 and implementing the display control of avatars corresponding to the plurality of distributed viewpoint images will be described below.

<2. Functional Configuration Example of Each Device>

(Functional configuration example of server 20)

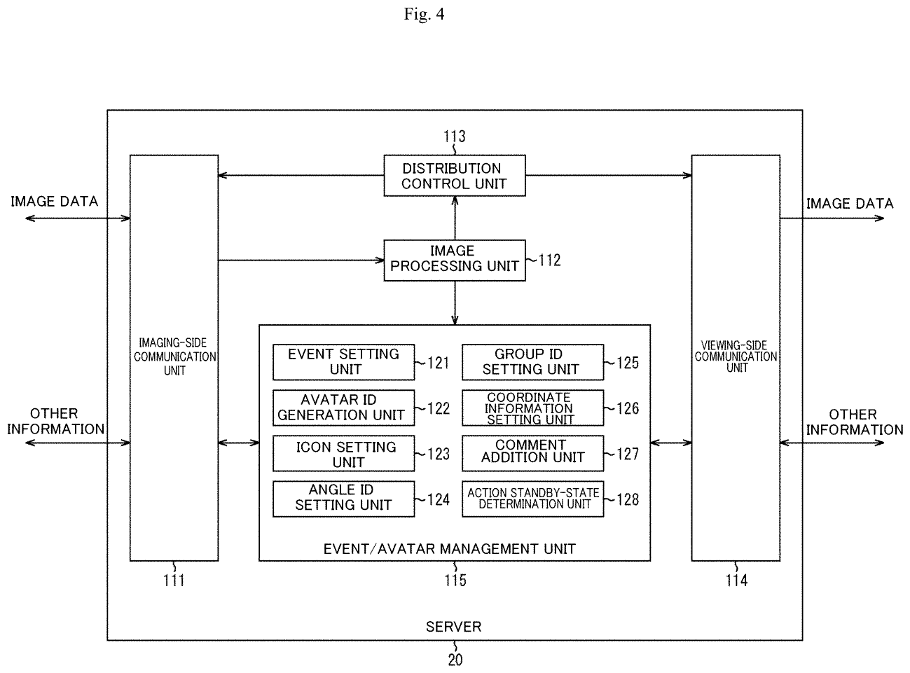

FIG. 4 is a block diagram illustrating a functional configuration example of the server 20.

The server 20 is configured as a cloud server for providing cloud computing service including web service.

The server 20 is configured to include an imaging-side communication unit 111, an image processing unit 112, a distribution control unit 113, a viewing-side communication unit 114, and an event/avatar management unit 115.

The imaging-side communication unit 111 transmits and receives image data and other information to and from the imaging-side terminals 10 via the Internet. Specifically, the imaging-side communication unit 111 receives viewpoint images from the imaging-side terminals 10 and transmits a composite image of the viewpoint images to each of the imaging-side terminals 10. Moreover, the imaging-side communication unit 111 receives position information on the imaging-side terminals 10 and transmits avatar information, which relates to the display of avatars corresponding to the users of the viewing-side terminals 30, to each of the imaging-side terminals 10.

The image processing unit 112 decodes viewpoint images, which are received from the imaging-side terminals 10 by the imaging-side communication unit 111, combines the images into one, and then the supplies the composite image to the distribution control unit 113. The image processing unit 112 supplies unique information for specifying viewpoint images from the imaging-side terminals 10, to the event/avatar management unit 115.

The distribution control unit 113 encodes the composite image obtained by the image processing unit 112 and controls the viewing-side communication unit 114 to distribute the image as a multi-stream distribution to the viewing-side terminals 30. The encoded multi-stream distribution is also provided to the imaging-side terminals 10.

The viewing-side communication unit 114 transmits and receives image data and other information to and from the viewing-side terminals 30 via the Internet. Specifically, the viewing-side communication unit 114 transmits a composite image of viewpoint images to each of the viewing-side terminals 30. Moreover, the viewing-side communication unit 114 receives position information on the viewing-side terminals 30 and information about users and transmits the avatar information to each of the viewing-side terminals 30.

The event/avatar management unit 115 manages events in which viewpoint images are captured by the imaging-side terminals 10 and avatars corresponding to users who are viewing the viewpoint images at the viewing-side terminals 30.

The event/avatar management unit 115 includes an event setting unit 121, an avatar ID generation unit 122, an icon setting unit 123, an angle ID setting unit 124, a group ID setting unit 125, a coordinate information setting unit 126, a comment addition unit 127, and an action standby-state determination unit 128.

The event setting unit 121 sets an event in which the users of the viewing-side terminals 30 can participate, by linking a plurality of viewpoint images captured in an event to a specific URL. The users of the viewing-side terminals 30 can view the viewpoint images of the corresponding event by accessing the URL from the viewing-side terminals 30. Moreover, viewpoint images from the imaging-side terminals 10 are uploaded to the server 20 by accessing a specific URL from the imaging-side terminals 10.

The avatar ID generation unit 122 generates an avatar ID specific to the avatar corresponding to the user of the viewing-side terminal 30 having accessed a URL corresponding to the event.

The icon setting unit 123 sets an icon for the avatar specified by the generated avatar ID. A face image used for an icon may be acquired from the viewing-side terminal 30 having accessed the URL or may be retained in advance in the server 20.

The angle ID setting unit 124 generates an angle ID for specifying an angle of the viewpoint image, on the basis of unique information for specifying the viewpoint image from the image processing unit 112. The angle ID setting unit 124 sets the angle ID of the viewpoint image for an avatar ID corresponding to a user who is viewing the viewpoint image.

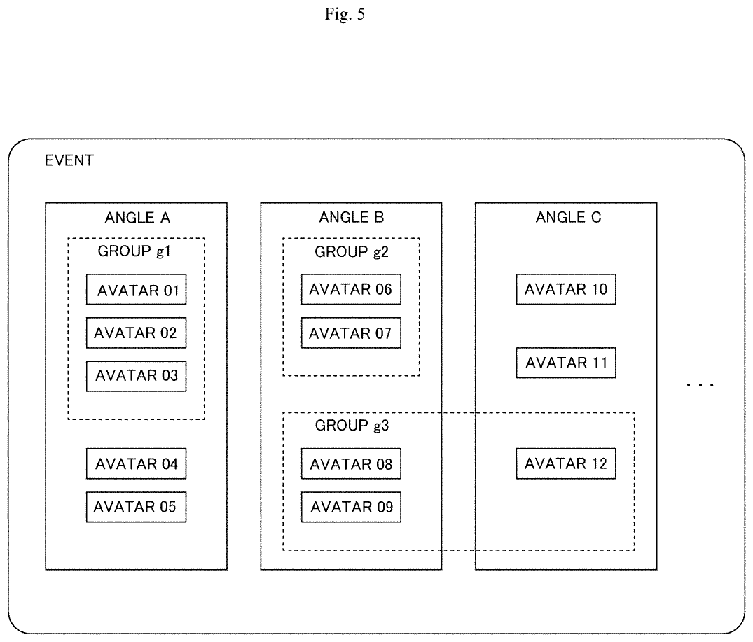

The group ID setting unit 125 sets a group ID for specifying a group created in an event, for an avatar ID corresponding to a user who has participated in the event. A group is created by a predetermined user who has participated in an event. The group ID of the group is set for an avatar ID corresponding to the user who has created the group. Moreover, the user who has creates the group invites another user to the group and the invited user participates the group, so that the group ID of the group is set for an avatar ID corresponding to the invited user. Referring to FIG. 5, a configuration example of event data generated for an event will be described below.

In the event data of FIG. 5, the avatar IDs of avatars 01 to 12 corresponding to 12 users are generated. Furthermore, angles A, B, and C are indicated as angle IDs corresponding to three viewpoint images.

In the example of FIG. 5, among the 12 users, the users of the avatars 01 to 05 view a viewpoint image specified by the angle A, so that the angle A is set for the avatars 01 to 05. The users of the avatars 06 to 09 view a viewpoint image specified by the angle B, so that the angle B is set for the avatars 06 to 09. The users of the avatars 10 to 12 view a viewpoint image specified by the angle C, so that the angle C is set for the avatars 10 to 12.

Among the avatar IDs set with the angle A, a group g1 is set as a group ID for the avatars 01 to 03. In other words, the users of the avatars 01 to 03 belong to the same group specified by the group g1.

Likewise, among the avatar IDs set with the angle B, a group g2 is set as a group ID for the avatars 06 and 07. In other words, the users of the avatars 06 and 07 belong to the same group specified by the group g2.

For the avatars 08 and 09 set with the angle B and the avatar 12 set with the angle C, a group g3 is set as a group ID across the angle IDs.

In this way, the users who are viewing the viewpoint image with the same angle can belong to one group. Since the users can switch viewpoint images (angles) to be viewed, the same angle ID is not always set for the avatar IDs belonging to the same group. Moreover, one user can belong to a plurality of groups.

Returning to the description of FIG. 4, the coordinate information setting unit 126 sets coordinate information indicating the display positions of the avatars corresponding the users, the avatars being displayed with the viewpoint images on the viewing-side terminals 30. The coordinate information indicates an absolute position on a two-dimensional plane corresponding to the screen of the viewing-side terminal 30 and is associated with all the avatar IDs included in one piece of event data.

The comment addition unit 127 adds a comment inputted on the viewing-side terminal 30, to the avatar corresponding to the user of the viewing-side terminal 30.

The action standby-state determination unit 128 determines an action standby-state of the avatar corresponding to the user of the viewing-side terminal 30, on the basis of standby state information indicating that the avatar is placed in a standby state of a specific motion (action), and then the action standby-state determination unit 128 generates information about the determination result.

As described above, the information generated and set by the units of the event/avatar management unit 115 is transmitted to the viewing-side terminals 30 as avatar information about the display of the avatars corresponding to the users.

(Functional Configuration Example of Imaging-Side Terminal 10)

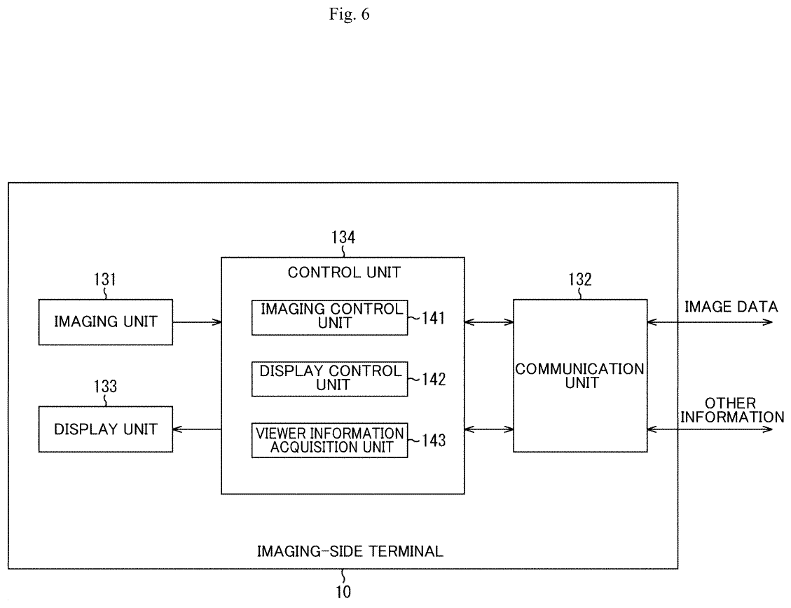

FIG. 6 is a block diagram illustrating a functional configuration example of the imaging-side terminal 10.

The imaging-side terminal 10 is not limited to an ordinary camera. A smartphone and a tablet or the like with the imaging function may be used as configurations.

The imaging-side terminal 10 is configured to include an imaging unit 131, a communication unit 132, a display unit 133, and a control unit 134.

The imaging unit 131 is configured with an optical system, which includes a lens, and an image sensor and captures a moving image as a viewpoint image.

The communication unit 132 transmits and receives image data and other information to and from the server 20 via the Internet. Specifically, the communication unit 132 transmits a viewpoint image captured by the imaging unit 131 to the server 20 and receives a composite image of a plurality of viewpoint images from the server 20. Moreover, the communication unit 132 transmits position information about the imaging-side terminals 10 to the server 20 and receives avatar information from the server 20 and feedback information about feedback including the comment from viewers. The feedback information also includes tap information for displaying a tap image, which will be described later.

The display unit 133 includes a liquid crystal display or an organic EL (Electro-Luminescence) display and displays a screen including an image from the server 20.

The control unit 134 includes a processor such as a CPU (Central Processing Unit) and controls the units of the imaging-side terminal 10. The control unit 134 operates a predetermined application to be executed on a browser or installed in the imaging-side terminal 10, thereby implementing an imaging control unit 141, a display control unit 142, and a viewer information acquisition unit 143.

The imaging control unit 141 acquires a viewpoint image by controlling the imaging unit 131 and transmits the acquired viewpoint image to the server 20 through the communication unit 132.

The display control unit 142 controls the display unit 133 such that a screen including an image received by the communication unit 132 is displayed on the display unit 133.

The viewer information acquisition unit 143 acquires avatar information or feedback information that is received by the communication unit 132. The display control unit 142 controls the display of avatars on the basis of the avatar information acquired by the viewer information acquisition unit 143.

(Functional Configuration Example of Viewing-Side Terminal 30)

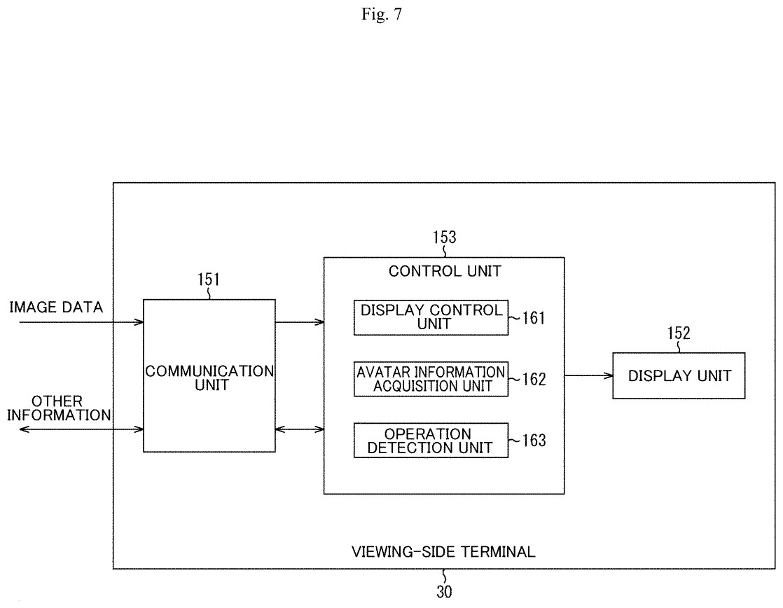

FIG. 7 is a block diagram illustrating a functional configuration example of the viewing-side terminal 30.

The viewing-side terminal 30 is configured as, for example, a smartphone, a tablet, or a PC (Personal Computer).

The viewing-side terminal 30 is configured to include a communication unit 151, a display unit 152, and a control unit 153.

The communication unit 151 transmits and receives image data and other information to and from the server 20 via the Internet. Specifically, the communication unit 151 receives a composite image of a plurality of viewpoint images from the server 20. Moreover, the communication unit 151 transmits position information about the viewing-side terminals 30 and information about the users to the server 20 and receives avatar information from the server 20.

The display unit 152 includes a liquid crystal display or an organic EL display and displays a screen including an image from the server 20.

The control unit 153 includes a processor such as a CPU and controls the units of the viewing-side terminal 30. The control unit 153 operates a predetermined application to be executed on a browser or installed in the viewing-side terminal 30, thereby implementing a display control unit 161, an avatar information acquisition unit 162, and an operation detection unit 163.

The display control unit 161 controls the display unit 152 such that a screen including an image received by the communication unit 151 is displayed on the display unit 152.

The avatar information acquisition unit 162 acquires avatar information received by the communication unit 151. The display control unit 161 controls the display of avatars on the basis of the avatar information acquired by the avatar information acquisition unit 162.

The operation detection unit 163 detects a user operation performed on the viewing-side terminal 30. The detection of a user operation includes the detection of the tilt of the viewing-side terminal 30 by an acceleration sensor in addition to the detection of operations on a button and a key, which are not illustrated, and a touch panel superimposed on the display unit 152.

<3. Display Mode of Viewpoint Image>

An example of a display mode of a viewpoint image on the viewing-side terminal 30 will be described below.

(Image Distribution Flow)

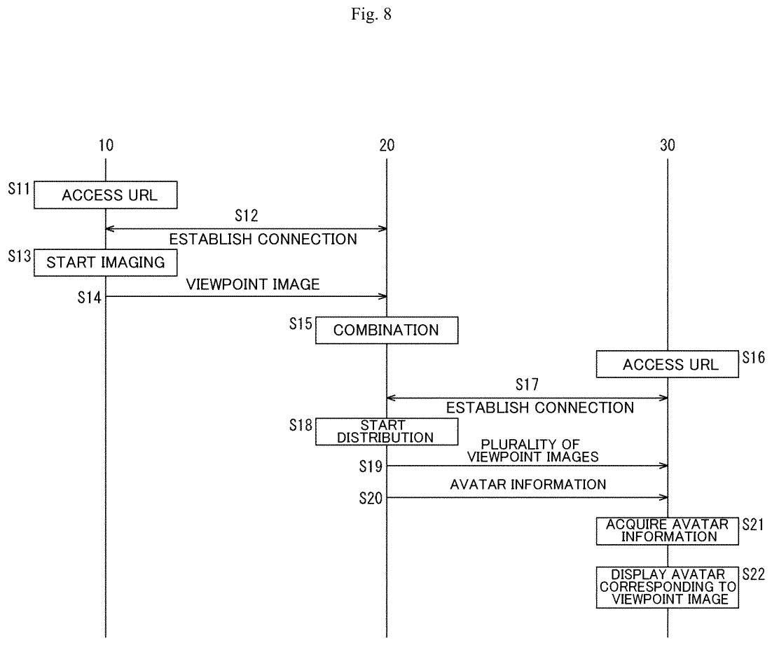

Referring to FIG. 8, the flow of image distribution in the image distribution system 1 will be described below.

In step S11, the imaging-side terminal 10 accesses a URL for uploading a viewpoint image. This establishes a connection between the imaging-side terminal 10 and the server 20 in step S12. At the URL, a limit to the maximum number of accessible imaging-side terminals 10 may be set.

In step S13, the imaging-side terminal 10 (imaging control unit 141) starts capturing a viewpoint image. In step S14, the imaging-side terminal 10 (communication unit 132) starts transmitting the captured viewpoint image to the server 20.

In step S15, the server 20 (image processing unit 112) combines a plurality of viewpoint images uploaded by the imaging-side terminals 10 into one image.

In step S16, the viewing-side terminal 30 accesses a URL for viewing the viewpoint image (in other words, for participating an event). This establishes a connection between the viewing-side terminal 30 and the server 20 in step S17. At the URL, a limit to the maximum number of accessible viewing-side terminals 30 is not set.

When the connection between the viewing-side terminal 30 and the server 20 is established, in step S18, the server 20 (distribution control unit 113) starts distributing a composite image of a plurality of viewpoint images.

Specifically, the server 20 (viewing-side communication unit 114) transmits a plurality of viewpoint images in step S19 and transmits avatar information corresponding to the users of the viewing-side terminals 30 in step S20.

In step S21, the viewing-side terminal 30 (avatar information acquisition unit 162) acquires the avatar information from the server 20.

In step S22, the viewing-side terminal 30 (display control unit 161) controls the display of avatars based on the avatar information, for a viewpoint image displayed on the terminal (display unit 152).

(Display of Viewpoint Image in Panoramic Mode)

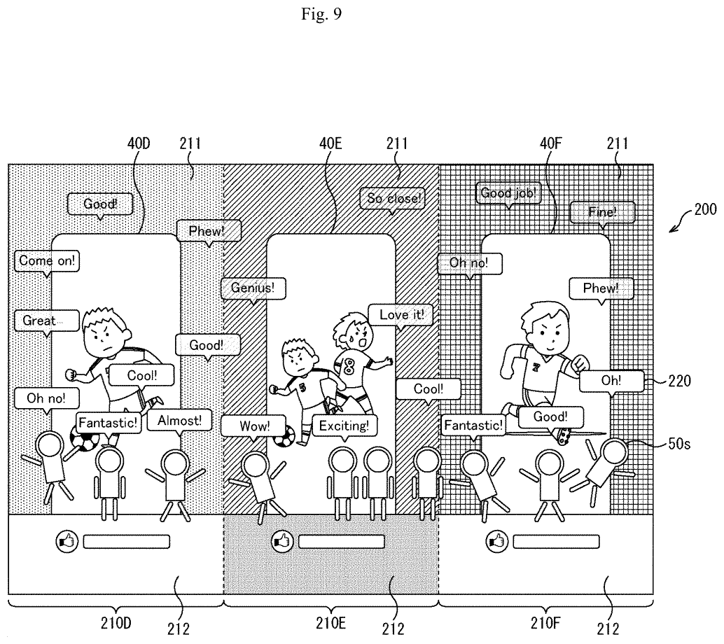

FIG. 9 illustrates an example of the display of viewpoint images in a panoramic mode, in which a plurality of viewpoint images are horizontally arranged on the viewing-side terminal 30.

A panoramic mode screen 200 in FIG. 9 is displayed when, for example, the viewing-side terminal 30 first accesses a URL for participating an event. In the panoramic mode, the user of the viewing-side terminal 30 views the viewpoint images on the panoramic mode screen 200 with the rectangular display unit 152 in landscape orientation (the horizontal longitudinal direction).

In the panoramic mode screen 200, a plurality of viewpoint images are laterally arranged in the order based on position information about the imaging-side terminals 10 having captured the images. In the example of FIG. 9, the three viewpoint images 40D, 40E, and 40F are displayed. The display is shifted to the viewpoint images 40A, 40B, and 40C, which are not illustrated, by user operations such as lateral swiping.

In the panoramic mode screen 200, display areas are separated for the respective viewpoint images. In the example of FIG. 9, display areas 210D, 210E, and 210F for the respective viewpoint images 40D, 40E, and 40F are shown.

The display areas 210D, 210E, and 210F (hereinafter also simply referred to as display areas 210) each include a background area 211 serving as the background of a viewpoint image and an evaluation area 212 for inputting a rating of a viewpoint image.

The background area 211 is a background image of a viewpoint image in the panoramic mode screen 200 and has a different color or design for each viewpoint image (angle).

The evaluation area 212 corresponds to the evaluation area 60 described with reference to FIG. 2 and includes a good button and a comment entry box. The evaluation area 212 also has a different color or design for each viewpoint image (angle).

In each of the display areas 210, other avatars 50s corresponding to other users are displayed in the lower end part of the viewpoint image. The other avatars 50s are disposed in the display area 210 corresponding to the viewpoint image viewed by the corresponding other users. Thus, for example, four other users corresponding to the other four avatars 50s displayed in the display area 210E are viewing the viewpoint image 40E.

In each of the display areas 210, comments 220 as text input by other users corresponding to the other avatars 50s are displayed in balloons above the corresponding other avatars 50s.

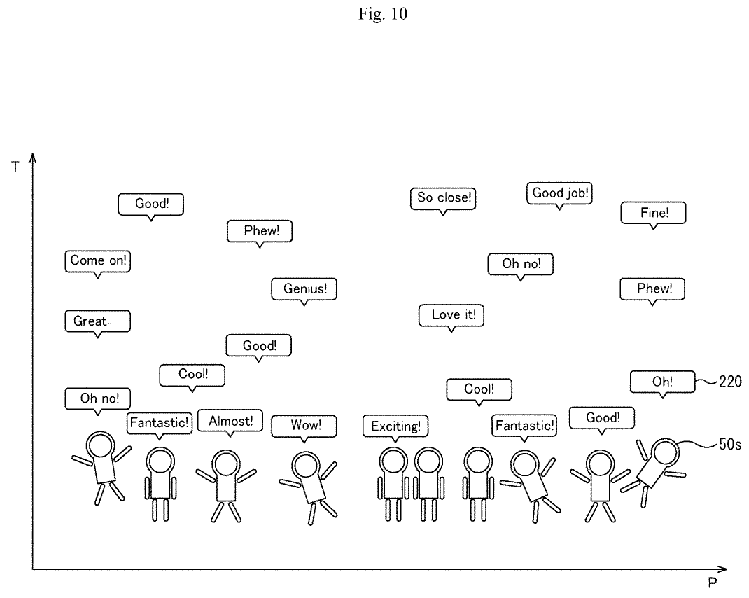

Referring to FIG. 10, the layout of comments corresponding to the avatars in the panoramic mode screen 200 will be described below. In this example, the layout of the other avatars 50s and the comments 220 in FIG. 9 will be described.

In FIG. 10, the horizontal axis indicates the positions P of avatars (other avatars 50s) in the panoramic mode screen 200 and the vertical axis indicates a time T at which text input of the comments 220 were performed by users corresponding to the avatars.

As described above, the avatar position P is located in the display area 210 corresponding to a viewpoint image viewed by each user. In the panoramic mode screen 200, viewpoint images are laterally arranged in the order based on positions where the viewpoint images are captured. Thus, it is assumed that the positions P of avatars in the panoramic mode screen 200 represent the virtual positions of users who participate in an event.

The comments 220 are displayed above the avatars corresponding to users who have entered text, so that the positions of the comments 220 in the horizontal axis agree with the positions P of the corresponding avatars. The earlier the time T of text input, the higher the comments 220 located in the vertical direction.

Thus, the comment 220 immediately after text input is located directly above the corresponding avatar and move upward with the passage of time.

In this way, in the panoramic mode screen 200, avatars are arranged in a first direction (horizontal direction) and the comments of text input by users corresponding to the avatars are arranged in the order of input in a second direction (vertical direction) orthogonal to the first direction.

The layout of avatars and comments is not limited to the panoramic mode screen 200 but is also applicable to a selection mode screen, which will be described later.

In the example of FIG. 9, the other avatars 50s corresponding to other users who are viewing two or more viewpoint images are displayed as avatars in the panoramic mode screen 200. By selecting any one of the viewpoint images, the user of the viewing-side terminal 30 on which the panoramic mode screen 200 is displayed can view the viewpoint image in the selection mode described with reference to FIG. 2.

When the panoramic mode screen 200 is displayed, the user has not selected any one of the viewpoint images, so that the self-avatar corresponding to the user is not displayed.

However, in the panoramic mode screen 200, a self-avatar may be displayed as an avatar in addition to the other avatars 50s.

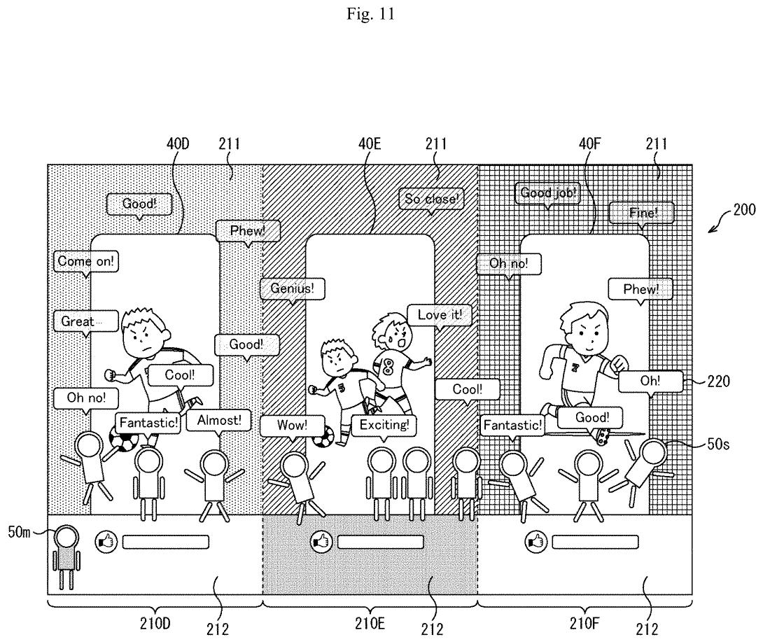

For example, as illustrated in FIG. 11, a self-avatar 50m of the user is displayed in an area (in the example of FIG. 11, the lower left part of the panoramic mode screen 200) different from the display areas of the other avatars 50s in the panoramic mode screen 200. This can provide the user with a feeling of participating in an event in which viewpoint images displayed in the panoramic mode screen 200 are captured.

In the foregoing description, a plurality of viewpoint images are laterally arranged in the panoramic mode screen 200. The layout is not limited thereto. The viewpoint images may be vertically arranged. In this case, avatars are arranged in the second direction (vertical direction) and the comments of text input by users corresponding to the avatars are arranged in the order of input in the first direction (horizontal direction). As in the layout of laterally arranged viewpoint images, the avatars may be arranged in the first direction (horizontal direction) and the comments may be arranged in the second direction (vertical direction).

In the panoramic mode screen 200, a plurality of viewpoint images may be arranged according to an actual positional relationship among the imaging-side terminals 10 or may be displayed in other regular patterns such as a circular pattern and a zigzag pattern.

(Display of Viewpoint Image in Selection Mode)

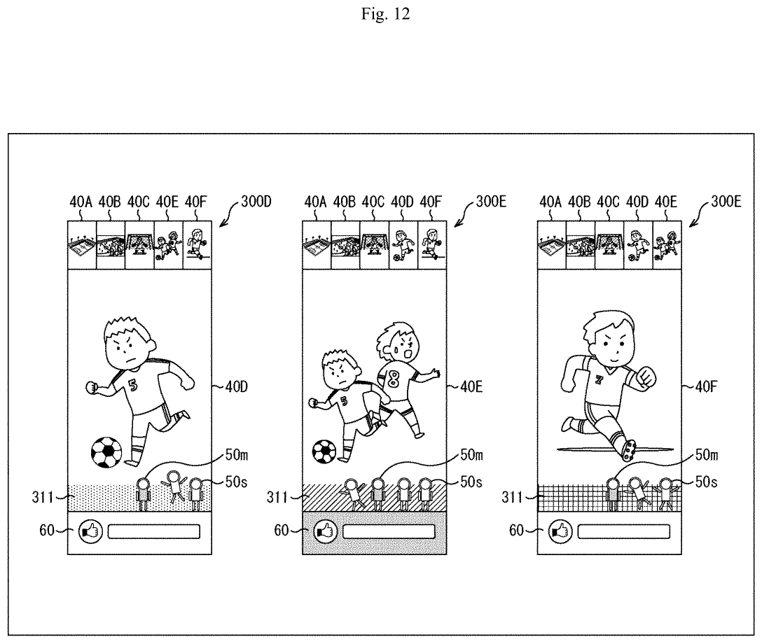

FIG. 12 illustrates an example of the display of viewpoint images in the selection mode in which any one of the viewpoint images is selected in the panoramic mode screen.

FIG. 12 shows three selection mode screens 300D, 300E, and 300F. The selection mode screen 300D is displayed when the viewpoint image 40D is selected in the panoramic mode screen 200 of FIG. 12. The selection mode screen 300E is displayed when the viewpoint image 40E is selected in the panoramic mode screen 200 of FIG. 12. The selection mode screen 300F is displayed when the viewpoint image 40F is selected in the panoramic mode screen 200 of FIG. 12.

In each of the selection mode screens 300D, 300E, and 300F (hereinafter also simply referred to as selection mode screens 300), the selected viewpoint image (selected viewpoint image) is largely displayed at the center while the other viewpoint images of small size are displayed in line in the upper part. Moreover, in the lower part of the selection mode screen 300, the evaluation area 60 for inputting a rating of the viewpoint image is provided. The evaluation area 60 has a different color or design for each viewpoint image (angle) like the evaluation area 212 in the panoramic mode screen 200 of FIG. 12.

Furthermore, in the selection mode screen 300, the self-avatar 50m is displayed at the center in the horizontal direction in the lower end part of the viewpoint image as an avatar corresponding to a user who is viewing the selected viewpoint image, whereas the other avatars 50s are displayed at predetermined positions on the right or left of the self-avatar 50m.

In the selection mode screen 300, a background image 311 is displayed in the background layer of the self-avatar 50m and the other avatars 50s. The background image 311 has a different color or design for each viewpoint image (angle) like the background area 211 in the panoramic mode screen 200 of FIG. 12.

As described with reference to FIG. 2, in the selection mode screen 300, the viewpoint image largely displayed at the center is switched when any one of other viewpoint images displayed in the upper part of the screen is selected by the user. At this point, the colors and designs of the background image 311 and the evaluation area 60 are also switched according to the selected viewpoint image (angle).

The colors and designs of the background image 311 and the evaluation area 60 (background area 211 and evaluation area 212) vary among the viewpoint images. Throughout an event, colors and designs with similar tones and atmospheres are preferably adopted according to the event. In the presence of a plurality of events, colors and designs with different tones and atmospheres are preferably adopted in the respective events. As a matter of course, colors and designs may be unified in an event regardless of the viewpoint images.

(Flow from Participation in Event to Viewing of Viewpoint Image)

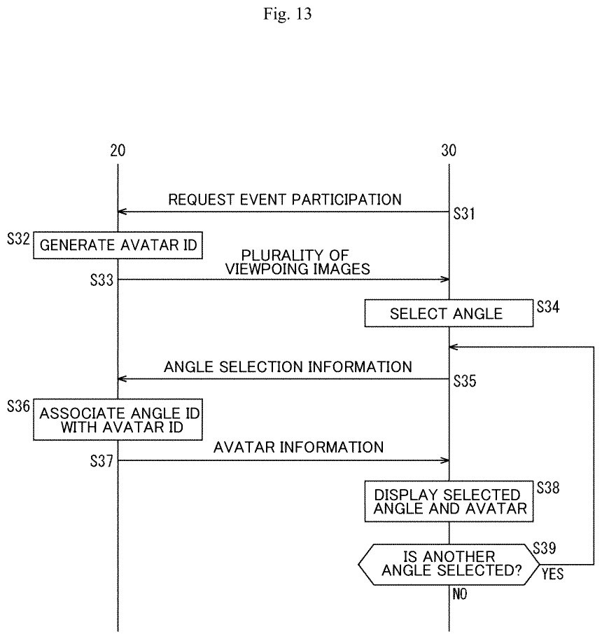

FIG. 13 is an explanatory drawing of a flow from participation in the event to the viewing of viewpoint images.

In step S31, the viewing-side terminal 30 (communication unit 151) transmits an event participation request to the server 20 by accessing a URL for participating the event. A face image used for an icon of a self-avatar may be transmitted with the event participation request.

In step S32, the server 20 (avatar ID generation unit 122) generates an avatar ID corresponding to the viewing-side terminal 30 having transmitted the event participation request.

In step S33, the server 20 (distribution control unit 113) distributes a composite image of a plurality of viewpoint images to the viewing-side terminal 30. Thus, on the viewing-side terminal 30, the panoramic mode screen is displayed as described with reference to FIG. 9.

When any one of the viewpoint images (angles) displayed on the panoramic mode screen of the viewing-side terminal 30 is selected in step S34, the viewing-side terminal 30 (communication unit 151) transmits angle selection information about the selected angle to server 20 in step S35.

In step S36, the server 20 (angle ID setting unit 124) associates (sets) an angle ID, which corresponds to the angle selection information from the viewing-side terminal 30, with the avatar ID generated in step S32.

In step S37, the server 20 (viewing-side communication unit 114) transmits avatar information for displaying the self-avatar set with an angle ID and other avatars set with the same angle ID, to the viewing-side terminal 30.

In step S38, the viewing-side terminal 30 (display control unit 161) controls the display of a selected angle (viewpoint image) and avatars (self-avatar and other avatars). Thus, on the viewing-side terminal 30, the selection mode screen is displayed as described with reference to FIG. 12.

In step S39, when another angle is selected on the selection mode screen, processing from step S35 is repeated to display the selected angle (viewpoint image) and the avatars (self-avatar and other avatars). If another angle is not selected on the selection mode screen in step S39, the displayed angle (viewpoint image) and avatars (the avatar of the user and other avatars) are continuously displayed.

According to the foregoing processing, the user can obtain an overall view of viewpoint images captured in an event, select desired one to be viewed from the viewpoint images, and switch the selected viewpoint image to another. The display of avatars changes depending upon displayed viewpoint images. This achieves a more realistic live stream of an event, allowing the user to join and enjoy the event from various viewpoints as in the real world.

<4. Animation Display of Avatar>

The viewing-side terminal 30 can provide the animation display of avatars.

(Walking of Avatar)

For example, in the selection mode screen, an avatar is allowed to walk.

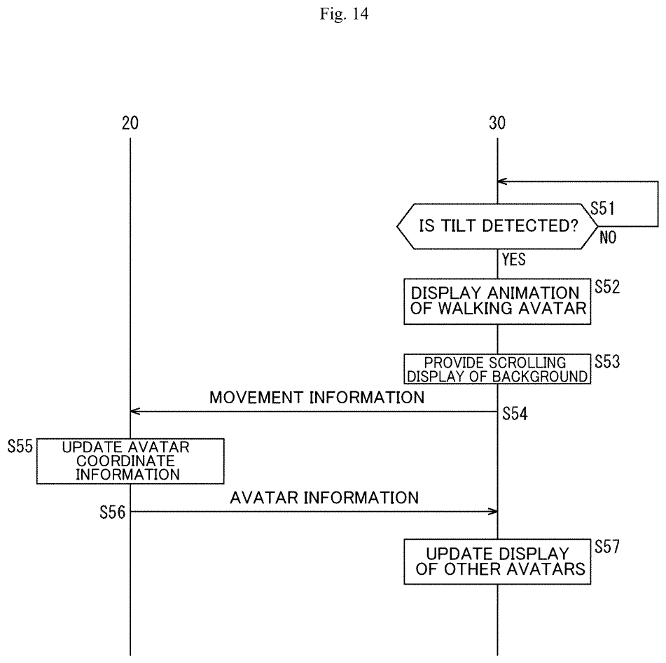

FIG. 14 is an explanatory drawing of a flow of avatar walking.

In step S51, the viewing-side terminal 30 (operation detection unit 163) determines whether the tilt of the viewing-side terminal 30 has been detected. In this case, it is assumed that the tilt is a tilt in a rotation direction with respect to the normal direction of the screen of the viewing-side terminal 30. The tilt is detected by the output of the acceleration sensor provided for the viewing-side terminal 30.

Step S51 is repeated until a tilt is detected. When a tilt is detected, the process advances to step S52.

In step S52, the viewing-side terminal 30 (display control unit 161) causes the display unit 152 to display an animation of a walking avatar (self-avatar).

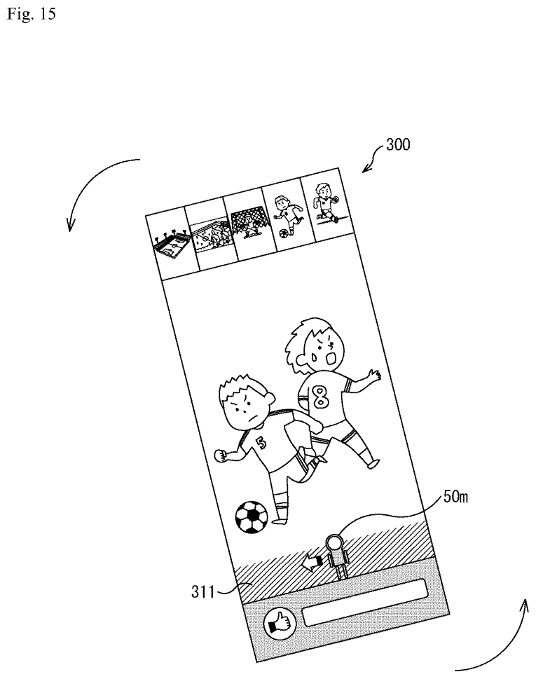

For example, as illustrated in FIG. 15, when the selection mode screen 300 displayed on the viewing-side terminal 30 tilts in the left rotation direction, the self-avatar 50m descends (leftward in FIG. 15) the tilt (the display position is changed) and is displayed in a walking form as an animation. The self-avatar 50m does not move to one end of the selection mode screen 300 according to the tilt of the selection mode screen 300. After a movement for a certain distance, the self-avatar 50m is displayed again at the center of the selection mode screen 300 in the horizontal direction.

In step S53, the viewing-side terminal 30 (display control unit 161) provides scrolling display of the background image 311 according to a movement of the self-avatar. For example, in the example of FIG. 15, the background image 311 scrolls opposite to (rightward) the moving direction (leftward) of the self-avatar 50m.

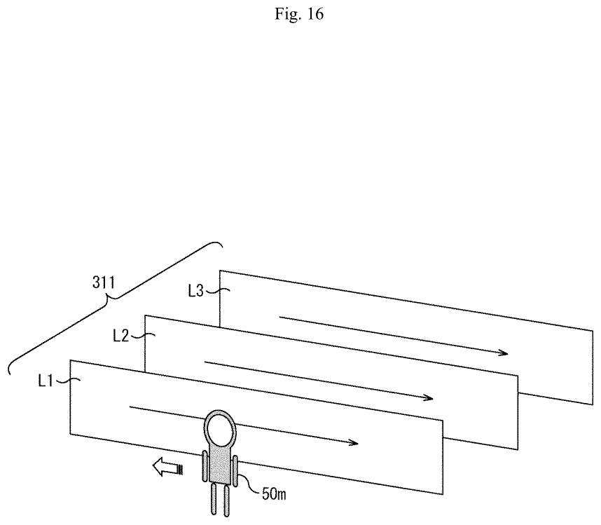

As illustrated in FIG. 16, the background image 311 may include a plurality of layers L1, L2, and L3. In the example of FIG. 16, the layer L1 constitutes a layer nearest the self-avatar 50m and the layer L3 constitutes a layer remotest from the self-avatar 50m. In the background image 311 configured thus, when the background image 311 scrolls opposite to the moving direction of the self-avatar 50m, the layer L1 near the self-avatar 50m is quickly scrolled while the layer L3 remote from the self-avatar 50m is slowly scrolled. This can represent a background with a sense of depth when the self-avatar 50m moves.

Returning to the description of FIG. 14, in step S54, the viewing-side terminal 30 (communication unit 151) transmits, to the server 20, movement information about a movement of the self-avatar according to the amount of tilt of the viewing-side terminal 30. The movement of the self-avatar in the movement information is not a movement of the self-avatar in the selection mode screen 300 but an absolute movement based on the amount of tilt of the viewing-side terminal 30.

In step S55, the server 20 (coordinate information setting unit 126) updates coordinate information about the avatar corresponding to the viewing-side terminal 30, on the basis of the movement information from the viewing-side terminal 30. The coordinate information about the avatar indicates a position on two-dimensional coordinates set for each viewpoint image (angle). Thus, among avatars corresponding to users who are viewing the same viewpoint image, the relative positions of other avatars are changed with respect to the position of the self-avatar.

In step S56, the server 20 (viewing-side communication unit 114) transmits avatar information about all avatars to the viewing-side terminals 30, the avatar information including the updated coordinate information. The avatar information is transmitted to the viewing-side terminals 30 of all users who are viewing the same viewpoint image as well as the viewing-side terminal 30 with a detected tilt.

In this case, all the avatars may be all avatars to be displayed at least on the viewing-side terminals 30. The same is applied hereinafter. Likewise, all the users may be all users corresponding to all avatars to be displayed. The same is applied hereinafter.

The avatars to be displayed include other avatars associated with the self-avatar (other avatars in the same group as the self-avatar) as well as the self-avatar. If a sufficient number of avatars is available to be displayed, the avatars to be displayed may include other avatars not associated with the self-avatar. Thus, even if an enormous number of users participate in an event, an appropriate number of pieces of avatar information can be transmitted and received.

In step S57, the viewing-side terminal 30 (display control unit 161 and avatar information acquisition unit 162) acquires avatar information from the server 20 and updates the display (layout) of other avatars with respect to the self-avatar in the selection mode screen 300.

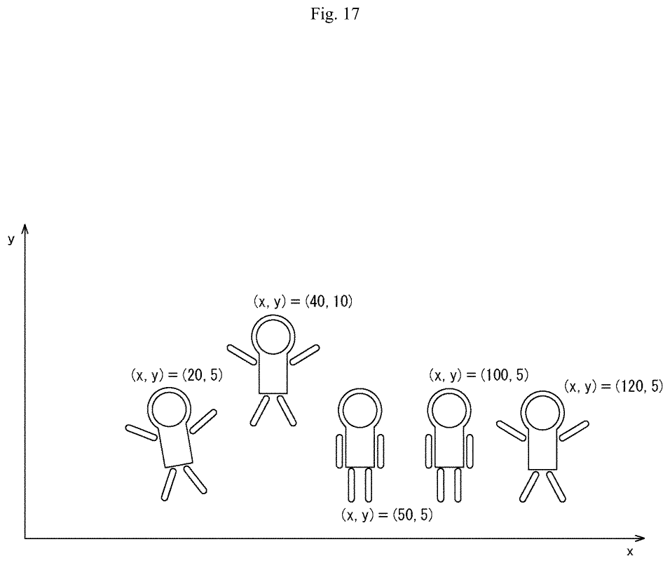

FIG. 17 illustrates an example of coordinate information about avatars in a certain viewpoint image (angle).

In FIG. 17, coordinate information about five avatars is indicated on xy coordinates. The x axis corresponds to a position in the horizontal direction in the selection mode screen 300 and the y axis corresponds to a position in the vertical direction in the selection mode screen 300.

As shown in FIG. 17, in the selection mode screen 300, the avatars can move in the vertical direction as well as the horizontal direction in animation display of, for example, jumps.

On the viewing-side terminals 30 of users corresponding to the respective avatars in FIG. 17, other avatars are arranged with respect to the self-avatar while keeping the positional relationship among the avatars in FIG. 17.

(Avatar Action Display 1)

In the selection mode screen, avatars are allowed to act according to a distance between the avatars.

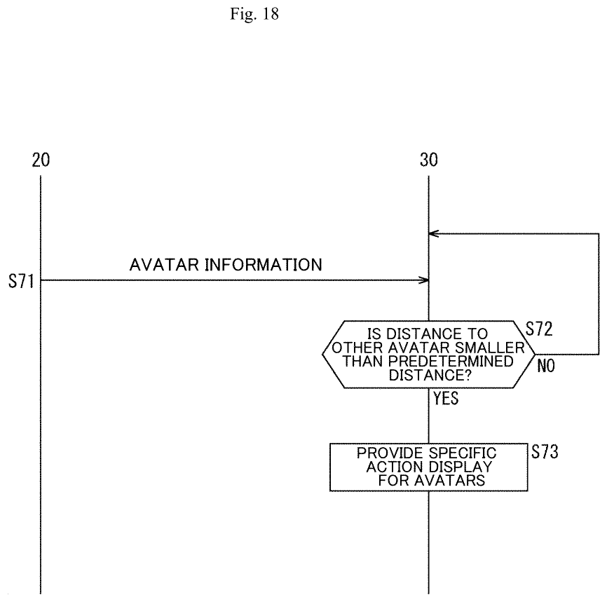

FIG. 18 is an explanatory drawing of a flow of avatar action display.

As described with reference to FIG. 14, the self-avatar moves according to the tilt of the viewing-side terminal 30. Other avatars may move instead.

In step S71, the server 20 (viewing-side communication unit 114) transmits avatar information about all avatars to the viewing-side terminals 30, the avatar information including updated coordinate information.

In step S72, the viewing-side terminal 30 (avatar information acquisition unit 162) determines whether a distance between the self-avatar and the other avatar (inter-avatar distance) is shorter than a predetermined distance on the basis of the coordinate information included in the avatar information from the server 20.

Step S72 is repeated until an inter-avatar distance is shorter than the predetermined distance. When an inter-avatar distance is shorter than the predetermined distance, the process advances to step S73.

In step S73, the viewing-side terminal 30 (display control unit 161) provides a specific action display for the avatars with an inter-avatar distance shorter than the predetermined distance.

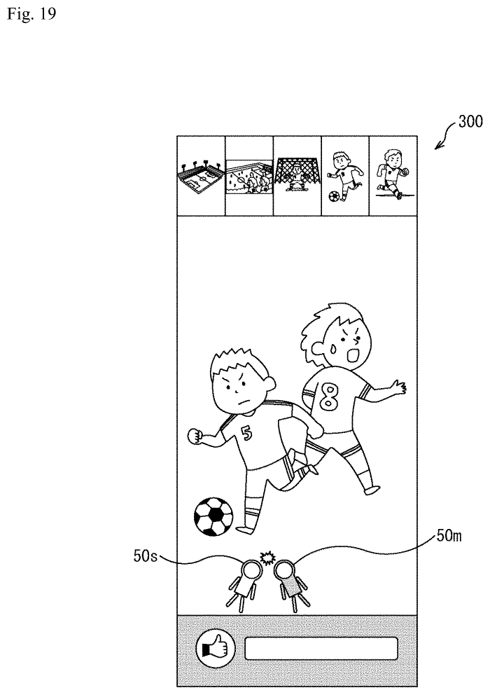

Specifically, as shown in FIG. 19, if a distance between the moving self-avatar 50m and other avatar 50s is shorter than the predetermined distance in the selection mode screen 300, the self-avatar 50m and the other avatar 50s collide with each other in animation display. Furthermore, after the animation display of a collision, the self-avatar 50m and the other avatar 50s may bounce up in animation display.

(Avatar Action Display 2)

In the selection mode screen, avatars are allowed to act according to a distance between the avatars on standby for a specific action.

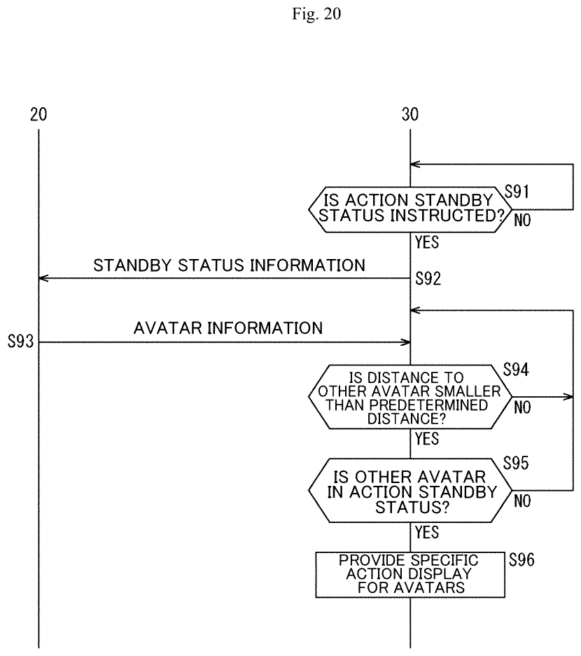

FIG. 20 is an explanatory drawing of a flow of avatar action display.

In step S91, the viewing-side terminal 30 (operation detection unit 163) determines whether the user has instructed the self-avatar to take a specific action (action standby status).

Step S91 is repeated until an instruction of an action standby status is provided. When an instruction of an action standby status is provided, the process advances to step S92.

In step S92, the viewing-side terminal 30 (communication unit 151) transmits standby status information about the self-avatar in an action standby status to the server 20.

In step S93, the server 20 (action standby-state determination unit 128, viewing-side communication unit 114) determines the action standby status of the avatar on the basis of the standby status information from the viewing-side terminal 30 and transmits the determination result and avatar information about all avatars to the viewing-side terminals 30, the avatar information including coordinate information.

As described with reference to FIG. 14, the self-avatar moves according to the tilt of the viewing-side terminal 30. Other avatars may move instead.

In step S94, the viewing-side terminal 30 (viewer information acquisition unit 143) determines whether a distance between the self-avatar and the other avatar (inter-avatar distance) is shorter than a predetermined distance on the basis of the coordinate information included in the avatar information from the server 20.

Step S94 is repeated until an inter-avatar distance is shorter than the predetermined distance. When an inter-avatar distance is shorter than the predetermined distance, the process advances to step S95.

In step S95, the viewing-side terminals 30 (avatar information acquisition unit 162) determines whether the other avatar at a distance shorter than the predetermined distance is also placed in an action standby status on the basis of the standby status information included in the avatar information from the server 20.

Steps S94 and S95 are repeated until the other avatar at a distance shorter than the predetermined distance is placed in an action standby status. When the other avatar at a distance shorter than the predetermined distance is placed in an action standby status, the process advances to step S96.

In step S96, the viewing-side terminal 30 (display control unit 161) provides a specific action display for the avatars in an action standby status with an inter-avatar distance shorter than the predetermined distance.

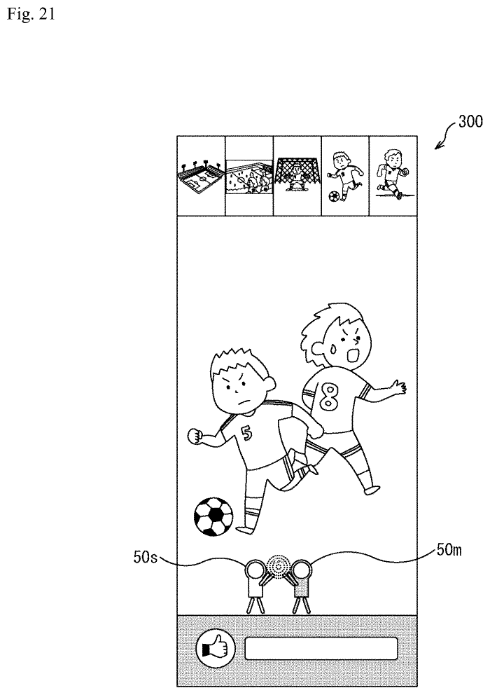

Specifically, as shown in FIG. 21, if a distance between the moving self-avatar 50m in an action standby status and the other avatar 50s is shorter than the predetermined distance and the other avatar 50s is also placed in an action standby status in the selection mode screen 300, the self-avatar 50m and the other avatar 50s high-five each other in animation display.

As described above, on the viewing-side terminal 30, avatars can be provided in various forms in animation display

<5. Preferential Display of Group and Avatar>

As described above, users can create a group in an event.

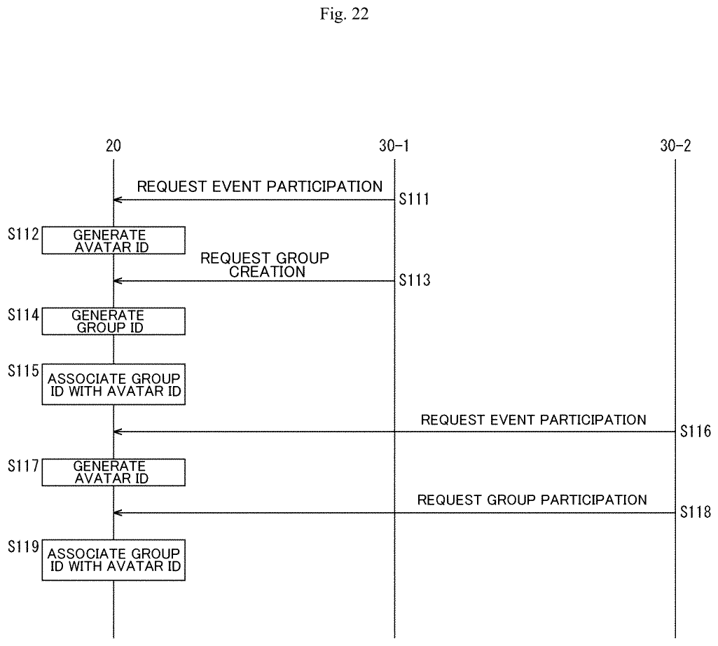

FIG. 22 is an explanatory drawing of a flow of group creation and participation in an event.

In step S111, a viewing-side terminal 30-1 (communication unit 151) transmits an event participation request to the server 20 by accessing a URL for participating the event.

In step S112, the server 20 (avatar ID generation unit 122) generates an avatar ID corresponding to the viewing-side terminal 30-1 having transmitted the event participation request.

In step S113, the viewing-side terminal 30-1 (communication unit 151) transmits a group creation request to the server 20 in response to an operation for creating a group in an event where the user has participated. The operation for creating a group is, for example, a press to a group creation button displayed on the screen of the viewing-side terminal 30-1. At this point, a group name or the like may be inputted.

In step S114, the server 20 (group ID setting unit 125) creates a group ID in response to the group creation request from the viewing-side terminal 30-1.

In step S115, the server 20 (group ID setting unit 125) associates (sets) the group ID, which is generated in step S114, with the avatar ID generated in step S112.

Thereafter, in order to invite the user of a viewing-side terminal 30-2 to a group, the user of the viewing-side terminal 30-1 transmits a URL for participating in an event and the group, to the viewing-side terminal 30-2 by using an e-mail or a predetermined massage function.

In step S116, the viewing-side terminal 30-2 (communication unit 151) having received the URL from the viewing-side terminal 30-1 transmits an event participation request to the server 20 by accessing the URL.

In step S117, the server 20 (avatar ID generation unit 122) generates an avatar ID corresponding to the viewing-side terminal 30-2 having transmitted the event participation request.

In step S118, the viewing-side terminal 30-2 (communication unit 151) transmits a group participation request to the server 20 in response to an operation for participating the group to which the user of the viewing-side terminal 30-1 has invited. The operation for participating the group is, for example, a press to a group participation button displayed on the screen of the viewing-side terminal 30-2.

In step S119, the server 20 (group ID setting unit 125) associates (sets) the group ID, which is generated in step S114, with the avatar ID generated in step S117.

As described above, a user can create a group in an event and invite other users to the group.

The selection mode screen 300 displays avatars corresponding to users who are viewing displayed viewpoint images. If viewpoint images are viewed by quite a number of users, the avatars are displayed in a complicated manner.

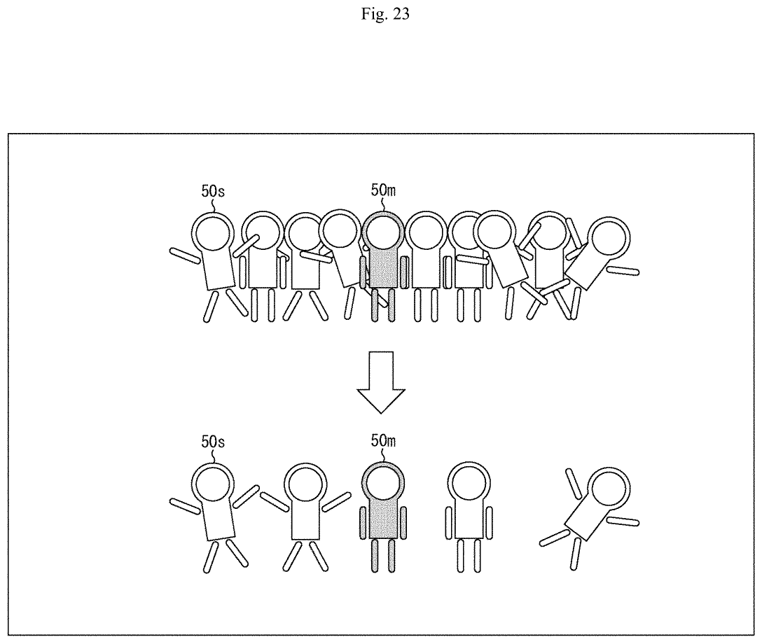

Thus, as illustrated in FIG. 23, if a large number of other avatars 50s are displayed in addition to the self-avatar 50m, the other avatars 50s corresponding to users having participated in the same group as the user are preferentially displayed.

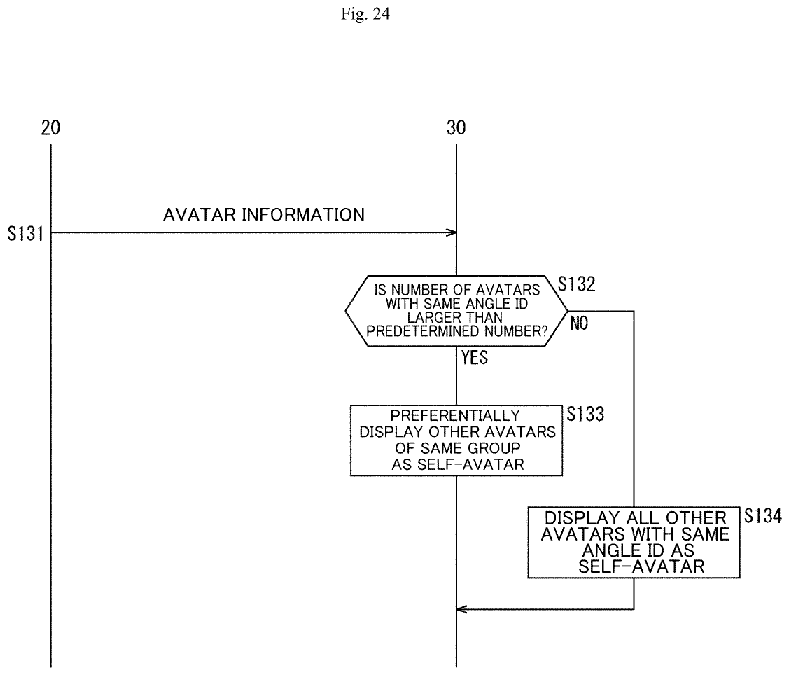

Referring to FIG. 24, a flow of preferential display of avatars will be described below.

In step S131, the server 20 (viewing-side communication unit 114) transmits, to the viewing-side terminals 30, avatar information about all avatars to be displayed on the viewing-side terminals 30. The avatar information is transmitted each time another avatar ID is generated or an update is performed on an angle ID, a group ID, or coordinate information that is associated with an avatar ID.

In step S132, the viewing-side terminal 30 (avatar information acquisition unit 162) acquires the avatar information from the server 20 and determines whether the number of other avatars with the same angle ID as that associated with the self-avatar is larger than a predetermined number.

If the number of other avatars with the same angle ID exceeds the predetermined number, the process advances to step S133.

In step S133, the viewing-side terminal 30 (display control unit 161) preferentially displays other avatars of the same group from among the self-avatar and the other avatars with the same angle ID.

At this point, if the total number of the self-avatar and the other avatars of the same group is smaller than a predetermined number, randomly selected other avatars may be displayed in addition to the self-avatar and the other avatars of the same group within the predetermined number.

If the total number of the self-avatar and the other avatars of the same group is smaller than the predetermined number, other avatars selected according to the viewing history of viewpoint images of other users may be displayed in addition to the self-avatar and the other avatars of the same group within the predetermined number.

Furthermore, if the total number of the self-avatar and the other avatars of the same group is smaller than the predetermined number, other avatars selected by the user may be displayed in addition to the self-avatar and the other avatars of the same group within the predetermined number.

If the number of other avatars with the same angle ID does not exceed the predetermined number, the process advances to step S134. The viewing-side terminal 30 (display control unit 161) displays the self-avatar and all the other avatars with the same angle ID.

As described above, if the number of avatars displayed on the viewing-side terminal 30 exceeds the predetermined number, among other avatars, other avatars associated with the self-avatar corresponding to the user of the viewing-side terminal 30 are preferentially displayed. This can prevent complicated display of avatars. The preferential display of avatars is not limited to the selection mode screen 300 and is also applicable to the panoramic mode screen 200.

<6. Other Display Variations>

Hereinafter, display variations on the viewing-side terminals 30 and imaging-side terminals 10 will be illustrated.

(Avatar Display Linked with Event)

On a screen where viewpoint images are displayed, goods or the like for an event where the viewpoint images are captured may be purchased through EC

(Electronic Commerce).

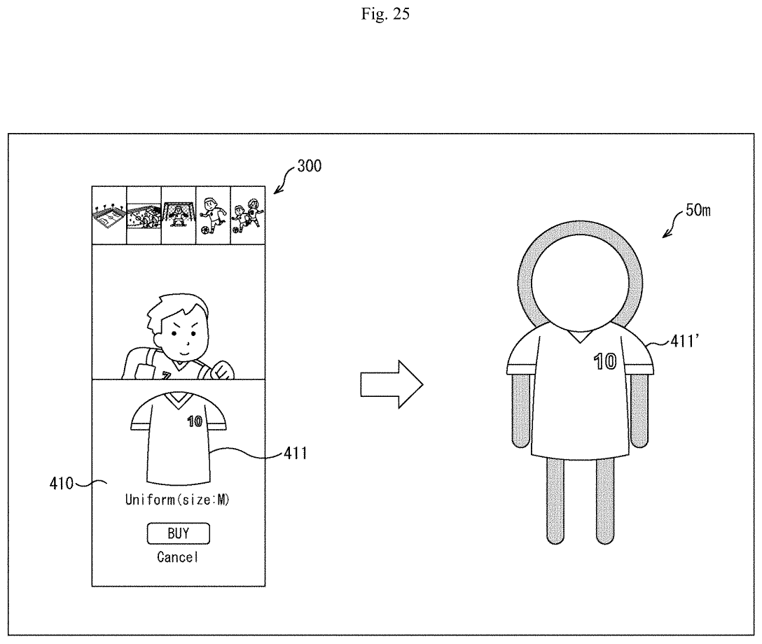

For example, as illustrated on the left side of FIG. 25, the selection mode screen 300 may display a purchase screen 410 where items relating to a soccer team in play can be purchased. In the example of FIG. 25, a uniform 411 of the soccer team is displayed on the purchase screen 410.

If a user decides to purchase the uniform 411 on the purchase screen 410, an image 411′ corresponding to the uniform 411 is synthesized with the self-avatar 50m as illustrated on the right side of FIG. 25.

In this way, display information related to an event is reflected on avatars, allowing the user to feel the realism of participation in the event.

(Switching of Avatar Display)

In the foregoing example, if the number of displayed avatars exceeds the predetermined number, other avatars associated with the self-avatar are preferentially displayed.

In addition, avatars to be displayed may be switched in response to a user operation.

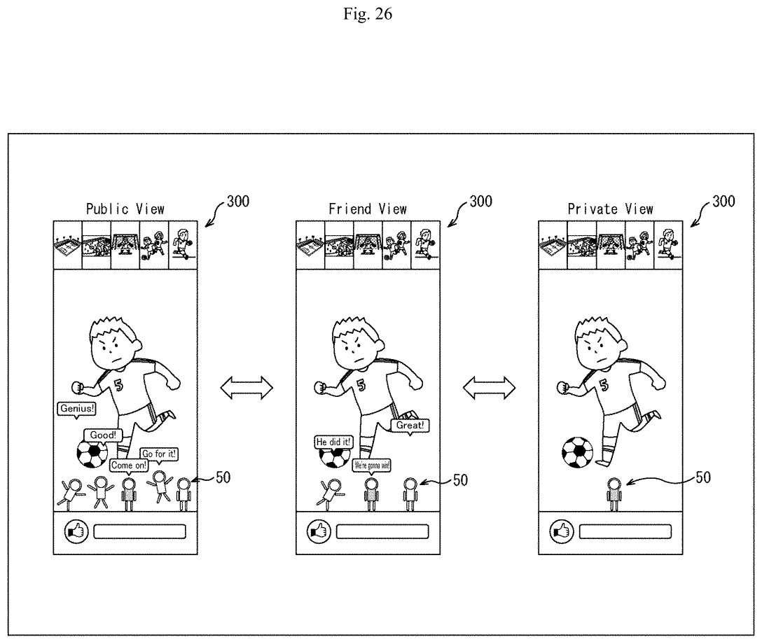

FIG. 26 illustrates an example of switching of avatar display.

FIG. 26 illustrates an example of avatar display in three patterns on the selection mode screen 300.

In FIG. 26, on the selection mode screen 300 (public view) on the left side, as avatars 50 to be displayed, other avatars corresponding to all users who are viewing the same viewpoint image (angle) are displayed as well as the self-avatar. In other words, the selection mode screen 300 of public view is compatible with a space where an indefinite number of participants gather at an event venue.

In FIG. 26, on the selection mode screen 300 (friend view) at the center, as avatars 50 to be displayed, other avatars corresponding to users who are viewing the same viewpoint image (angle) as the self-avatar in the same group are displayed. In other words, the selection mode screen 300 of friend view is compatible with a space where only the user and friends participate.

In FIG. 26, on the selection mode screen 300 (private view) on the right side, as the avatar 50 to be displayed, only the self-avatar is displayed and any other avatars are not displayed. In other words, the selection mode screen 300 of private view is compatible with a space where only the user is present.

The avatar display in three patterns of FIG. 26 is switched by operations such as pinch in/pinch out on the selection mode screen 300. For example, by a pinch-in gesture, the number of displayed avatars decreases such that the display of the selection mode screen 300 shifts from the left to the right in FIG. 26, whereas by a pinch-out gesture, the number of displayed avatars increases such that the display of the selection mode screen 300 shifts from the right to the left in FIG. 26.

Operations for switching avatars to be displayed are not limited to pinch-in/pinch-out gestures. Other operations such as a swipe in a predetermined direction and a predetermined number of times of tapping may be performed on the selection mode screen 300.

(Evaluation of Comment)

Comments of text input about a viewpoint image by other users may be evaluated.

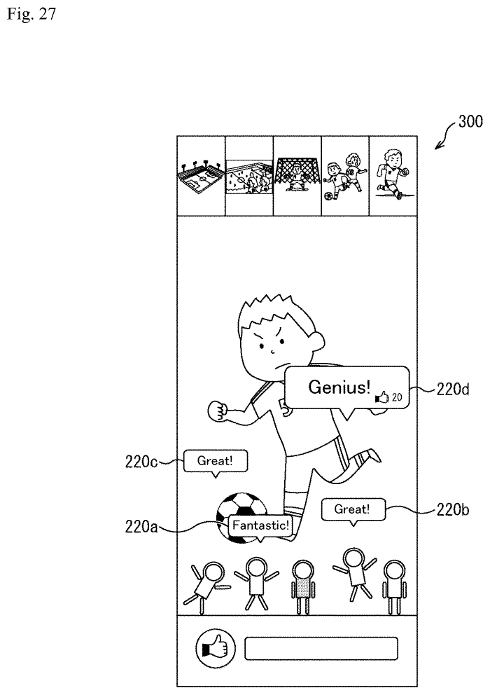

For example, on the selection mode screen 300 in FIG. 27, comments 220a, 220b, 220c, and 220d as text input by other users are displayed as comments 220.

The comment 220d is displayed larger than the other comments 220a, 220b, and 220c by tapping multiple times by users who are viewing the same viewpoint image. In the balloon of the comment 220d, the number of times of tapping is displayed in addition to entered text. The displayed comments 220 increase in size with the number of times of tapping.

In this way, comments are largely displayed according to the number of times of tapping, providing an at-a-glance view of comments attracting sympathy with other users.

(Display of Viewpoint Image on Imaging-Side Terminal)

The display of viewpoint images on the viewing-side terminal 30 was described above. Viewpoint images are also displayed on the imaging-side terminal 10 as in the selection mode screen 300 of the viewing-side terminal 30.

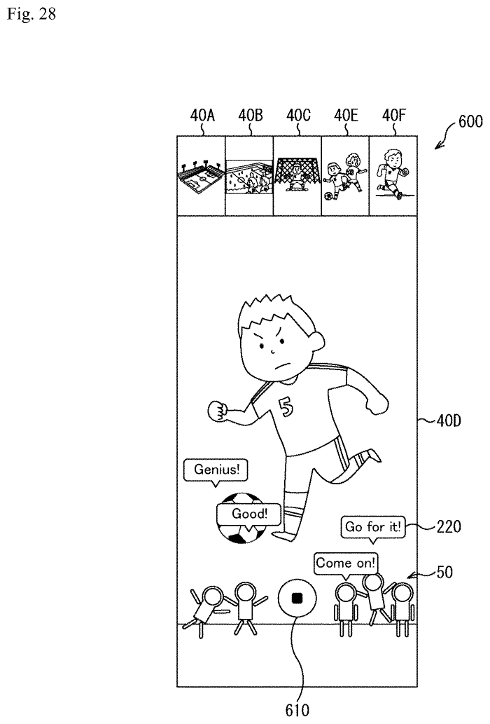

FIG. 28 illustrates a display example of viewpoint images on the imaging-side terminal 10.

An imaging screen 600 in FIG. 28 is displayed on the imaging-side terminal 10 (display unit 133) that has captured the viewpoint image 40D.

On the imaging screen 600, the viewpoint image 40D captured by the imaging-side terminal 10 is largely displayed at the center, and the other viewpoint images 40A to 40C, 40E, and 40F of small size are displayed in line in the upper part.

Moreover, on the imaging screen 600, the avatars 50 corresponding to users who are viewing the viewpoint image 40D are displayed in the lower end part of the viewpoint image 40D. The avatars 50 are displayed at positions based on coordinate information. On the imaging screen 600, the comments 220 as text input by the users corresponding to the avatars 50 are displayed in balloons above the corresponding avatars 50.

Moreover, on the imaging screen 600, a recording button 610 for starting/terminating recording of the viewpoint image 40D is displayed at the center of the lower end part of the viewpoint image 40D.

In this way, on the imaging screen 600, other viewpoint images are displayed with the viewpoint image being captured by the imaging-side terminal 10. This allows a photographer of the imaging-side terminal 10 to confirm viewpoint images being captured by other photographers, thereby capturing a viewpoint image in cooperation with other photographers.

Moreover, on the imaging screen 600, the avatars 50 corresponding to users (viewers) who are viewing the viewpoint image and the comments 220 are displayed with a viewpoint image being captured by the imaging-side terminal 10. This allows a photographer of the imaging-side terminal 10 to confirm the reactions of viewers in real time while capturing the viewpoint image.

Such feedback from viewers to a photographer contributes to motivation for capturing viewpoint images with more proper angles by the photographer.

Thus, a part requested by viewers in a viewpoint image may be fed back to the photographer in real time.

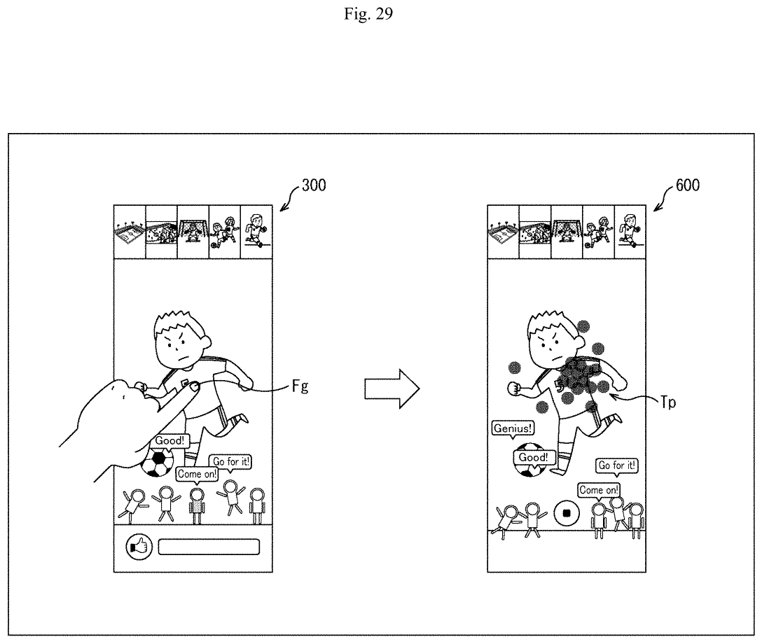

For example, as illustrated in FIG. 29, a requested part in a viewpoint image is tapped with a finger Fg of a user (viewer) on the selection mode screen 300 of the viewing-side terminal 30. At this point, on the imaging screen 600 of the imaging-side terminal 10, tapping images Tp indicating portions tapped with the finger Fg are superimposed on the viewpoint image being captured.

This allows a photographer to capture a viewpoint image with an angle around points where the multiple tapping images Tp are displayed.

(Display of Object)

As an evaluation of a viewpoint image by users who are viewing the viewpoint image, various objects (characters or images) may be displayed in addition to the comments 220.

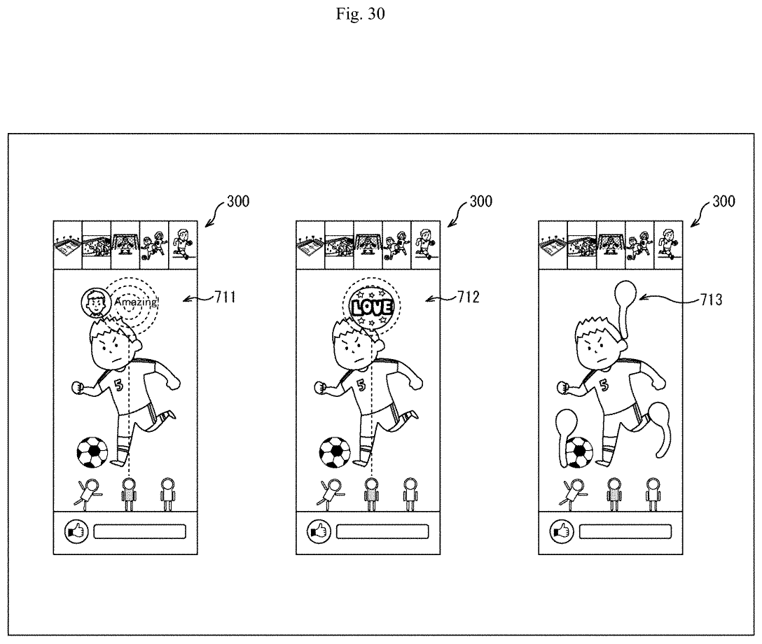

FIG. 30 illustrates an example of the display of objects.

In the selection mode screen 300 on the left side of FIG. 30, an object 711 is displayed like fireworks from a self-avatar on a viewpoint image. The object 711 is a combination of a face image used for an icon of the self-avatar and a character string. The character string of the object 711 may be a preset character string or text input by a user.

In the selection mode screen 300 at the center of FIG. 30, an object 712 like a fan with a message is displayed like fireworks from a self-avatar on a viewpoint image.

In the selection mode screen 300 on the right side of FIG. 30, an object 713 is displayed like rocket balloons from avatars on a viewpoint image.

In this way, various objects are displayed on the viewpoint image in addition to the comments 220, allowing the user to evaluate the viewpoint image as in the real world.

(Map View)

In the foregoing description, the viewing-side terminal 30 accesses a URL for participating in an event, allowing the user to participating in the event.

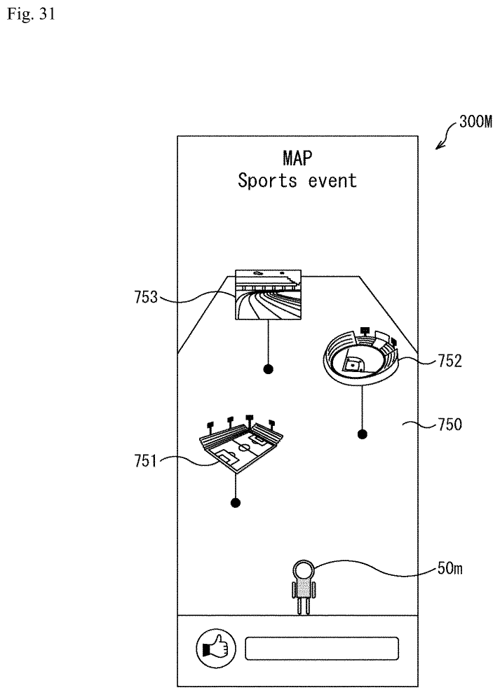

Additionally, a map view screen 300M in FIG. 31 may be displayed on the viewing-side terminal 30. The self-avatar 50m and a virtual map 750 are displayed on the map view screen 300 M.

On the virtual map 750, icons 751, 752, and 753 indicating event venues are displayed with reference to the self-avatar 50m on the basis of position information about the viewing-side terminal 30 and map information about the event venues of events.

The user searches for the icon of a desired event and selects the icon on the map view screen 300M, so that the user can participate in the event. On the map view screen 300M, other avatars corresponding to other users may be displayed such that the user can join friends who are participating the event.

<7. Configuration Example of Computer>

The above-described series of processing can also be executed by hardware or software. When the series of processing is performed by software, a program for the software is embedded in dedicated hardware to be installed from a program recording medium to a computer or a general-purpose personal computer.

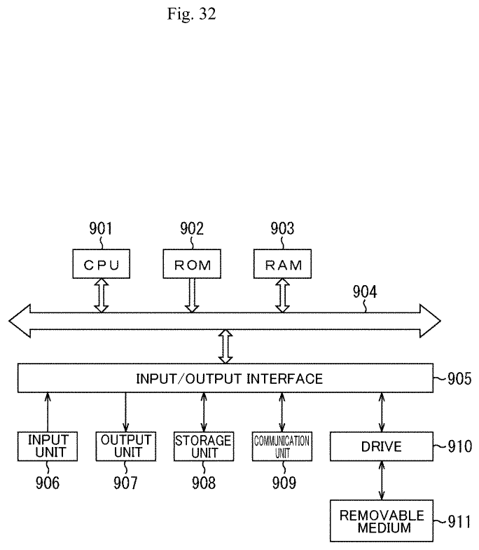

FIG. 32 is a block diagram illustrating a configuration example of computer hardware that executes the above-described series of processing using a program.

The imaging-side terminal 10, the server 20, and the viewing-side terminal 30, which serve as information processing devices to which the technique of the present disclosure is applicable, are implemented by a computer configures as illustrated in FIG. 32.

A CPU 901, a ROM (Read-Only Memory) 902, and a RAM (Random Access Memory) 903 are connected to one another via a bus 904.

An input/output interface 905 is further connected to the bus 904. An input unit 906 including a keyboard and a mouse and an output unit 907 including a display and a speaker are connected to the input/output interface 905. In addition, a storage unit 908 including a hard disk, a non-volatile memory, and the like, a communication unit 909 including a network interface and the like, and a drive 910 that drives a removable medium 911 are connected to the input/output interface 905.

In the computer configured thus, for example, the CPU 901 performs the series of processes by loading a program stored in the storage unit 908 to the RAM 903 via the input/output interface 905 and the bus 904 and executing the program.

The program executed by the CPU 901 is recorded on, for example, the removable medium 911 or is provided via a wired or wireless transfer medium such as a local area network, the Internet, or a digital broadcast to be installed in the storage unit 908.

The program executed by the computer may be a program that performs processing chronologically in the order described in the present specification or may be a program that performs processing in parallel or at a necessary timing such as a called time.

The embodiments of the present disclosure are not limited to the above-described embodiments, and various modifications can be made without departing from the essential spirit of the present disclosure.

The advantageous effects described in the present specification are merely exemplary and are not limited, and other advantageous effects may be achieved.

Furthermore, the present disclosure can be configured as follows.

(1)

An information processing device including a display control unit that displays, on a terminal, a plurality of viewpoint images captured at different viewpoints in an event; and
an avatar information acquisition unit that acquires avatar information about display of avatars corresponding to each of a user who is viewing the plurality of viewpoint images displayed on the terminal and other users who are viewing the plurality of viewpoint images on other terminals,
wherein
the display control unit controls the display of the avatars based on the avatar information, for the viewpoint images displayed on the terminal.

(2)

The information processing device according to (1), wherein the display control unit displays, with a viewpoint image selected by the user from among the plurality of viewpoint images, a self-avatar corresponding to the user and other avatars corresponding to the other users who are viewing the selected viewpoint image on the other terminals.

(3)

The information processing device according to (2), wherein the display control unit switches the other avatars to be displayed, in response to an operation of the user.

(4)

The information processing device according to (3), wherein the display control unit switches between display of the other avatars of the same group as the self-avatar as the other avatars to be displayed and display in the absence of any one of the other avatars.

(5)

The information processing device according to (1), wherein the display control unit displays other avatars corresponding to the other users who are watching at least two of the plurality of viewpoint images, along with the at least two viewpoint images of the plurality of images.

(6)

The information processing device according to (5), wherein the display control unit does not display a self-avatar corresponding to the user.

(7)

The information processing device according to (5), wherein the display control unit displays a self-avatar corresponding to the user in an area different from the display areas of the other avatars.

(8)

The information processing device according to any one of (1) to (7), wherein the display control unit arranges the avatars in a first direction and arranges comments of text input by the user or the other users, which correspond to the avatars, in the order of input in a second direction orthogonal to the first direction.

(9)

The information processing device according to any one of (1) to (8), wherein the display control unit displays a background image corresponding to the event, in a background layer of the avatars in addition to the plurality of viewpoint images and the avatars.

(10)

The information processing device according to (9), wherein the display control unit displays the different background image for each of the plurality of viewpoint images.

(11)

The information processing device according to any one of (1) to (4), wherein the display control unit controls a motion of the self-avatar corresponding to the user, in response to an operation of the user on the terminal.

(12)

The information processing device according to (11), wherein the display control unit changes the display position of the self-avatar according to the tilt of the terminal.

(13)

The information processing device according to (12), wherein the display control unit controls the motions of the self-avatar and the other avatars according to an inter-avatar distance between the self-avatar and the other avatars corresponding to the other users.

(14)

The information processing device according to (13), wherein the display control unit causes the self-avatar and the other avatars to make a specific motion when the inter-avatar distance is smaller than a predetermined distance.

(15)

The information processing device according to (13), wherein the display control unit causes the self-avatar and the other avatars to make a specific motion when the self-avatar and the other avatars are placed in a standby state of the specific motion and the inter-avatar distance is smaller than a predetermined distance.

(16)

The information processing device according to any one of (1) to (15), wherein the display control unit synthesizes, to a part corresponding to the head of the avatar, an image specific for the user corresponding to the avatar or the other users.

(17)

The information processing device according to any one of (1) to (16), wherein the display control unit reflects display information related to the event on the avatars.

(18)

The information processing device according to any one of (1) to (17), wherein if the number of avatars to be displayed on the terminal exceeds a predetermined number, the display control unit preferentially displays, from among the other avatars corresponding to the other users, the other avatars associated with the self-avatar corresponding to the user and displays the self-avatar and the other avatars such that the number of avatars to be displayed is within the predetermined number.

(19)

The information processing device according to (18), wherein the display control unit displays the randomly selected other avatars within the predetermined number in addition to the self-avatar and the other avatars associated with the self-avatar.

(20)

The information processing device according to (18), wherein the display control unit displays the other avatars, which are selected according to the viewing history of the other users, within the predetermined number in addition to the self-avatar and the other avatars associated with the self-avatar.

(21)

The information processing device according to (18), wherein the display control unit displays the other avatars, which are selected by the user, within the predetermined number in addition to the self-avatar and the other avatars associated with the self-avatar.

(22)

An information processing method causing an information processing device to: display, on a terminal, a plurality of viewpoint images captured at different viewpoints in an event;
acquire avatar information about display of avatars corresponding to each of a user who is viewing the plurality of viewpoint images displayed on the terminal and other users who are viewing the plurality of viewpoint images on other terminals; and
control the display of the avatars based on the avatar information, for the viewpoint images displayed on the terminal.

(23)

A program causing a computer to execute processing of
displaying, on a terminal, a plurality of viewpoint images captured at different viewpoints in an event;
acquiring avatar information about display of avatars corresponding to each of a user who is viewing the plurality of viewpoint images displayed on the terminal and other users who are viewing the plurality of viewpoint images on other terminals; and
controlling the display of the avatars based on the avatar information, for the viewpoint images displayed on the terminal.

(24)

An information processing device including a distribution control unit that distributes a plurality of viewpoint images captured at different viewpoints in an event, to the terminals of a plurality of users;
a coordinate information setting unit that sets coordinate information indicating the display positions of the avatars corresponding the users, the avatars being displayed with the viewpoint videos on the terminals; and
a communication unit that transmits avatar information about the display of the avatars to the terminals, the avatar information including the coordinate information.

### REFERENCE SIGNS LIST

1 Image distribution system
10 Imaging-side terminal
20 Server
30 Viewing-side terminal
50 Avatar
50m Self-avatar
50s Other avatars
71 Body
72 Icon
111 Imaging-side communication unit
112 Image processing unit
113 Distribution control unit
114 Viewing-side communication unit
115 Event/avatar management unit
121 Event setting unit
122 Avatar ID generation unit
123 Icon setting unit
124 Angle ID setting unit
125 Group ID setting unit
126 Coordinate information setting unit
127 Comment addition unit
128 Action standby-state determination unit
131 Imaging unit
132 Communication unit
133 Display unit
134 Control unit
141 Imaging control unit
142 Display control unit
143 Avatar information acquisition unit
151 Communication unit
152 Display unit
153 Control unit
161 Display control unit
162 Avatar information acquisition unit
163 Operation detection unit

1. An information processing device comprising: a display control unit that displays, on a terminal, a plurality of viewpoint images captured at different viewpoints in an event; and
an avatar information acquisition unit that acquires avatar information about display of avatars corresponding to each of a user who is viewing the plurality of viewpoint images displayed on the terminal and other users who are viewing the plurality of viewpoint images on other terminals,
wherein
the display control unit controls the display of the avatars based on the avatar information, for the viewpoint images displayed on the terminal.

2. The information processing device according to claim 1, wherein the display control unit displays, with a viewpoint image selected by the user from among the plurality of viewpoint images, a self-avatar corresponding to the user and other avatars corresponding to the other users who are viewing the selected viewpoint image on the other terminals.

3. The information processing device according to claim 2, wherein the display control unit switches the other avatars to be displayed, in response to an operation of the user.

4. The information processing device according to claim 3, wherein the display control unit switches between display of the other avatars of the same group as the self-avatar as the other avatars to be displayed and display in absence of any one of the other avatars.

5. The information processing device according to claim 1, wherein the display control unit displays other avatars corresponding to the other users who are watching at least two of the plurality of viewpoint images, along with the at least two viewpoint images of the plurality of images.

6. The information processing device according to claim 5, wherein the display control unit does not display a self-avatar corresponding to the user.

7. The information processing device according to claim 5, wherein the display control unit displays a self-avatar corresponding to the user in an area different from display areas of the other avatars.

8. The information processing device according to claim 1, wherein the display control unit arranges the avatars in a first direction and arranges comments of text input by the user or the other users, which correspond to the avatars, in order of input in a second direction orthogonal to the first direction.

9. The information processing device according to claim 1, wherein the display control unit displays a background image corresponding to the event, in a background layer of the avatars in addition to the plurality of viewpoint images and the avatars.

10. The information processing device according to claim 9, wherein the display control unit displays the different background image for each of the plurality of viewpoint images.

11. The information processing device according to claim 1, wherein the display control unit controls a motion of the self-avatar corresponding to the user, in response to an operation of the user on the terminal.

12. The information processing device according to claim 11, wherein the display control unit changes a display position of the self-avatar according to a tilt of the terminal.

13. The information processing device according to claim 12, wherein the display control unit controls the motions of the self-avatar and the other avatars according to an inter-avatar distance between the self-avatar and the other avatars corresponding to the other users.

14. The information processing device according to claim 13, wherein the display control unit causes the self-avatar and the other avatars to make a specific motion when the inter-avatar distance is smaller than a predetermined distance.

15. The information processing device according to claim 13, wherein the display control unit causes the self-avatar and the other avatars to make a specific motion when the self-avatar and the other avatars are placed in a standby state of the specific motion and the inter-avatar distance is smaller than a predetermined distance.

16. The information processing device according to claim 1, wherein the display control unit synthesizes, to a part corresponding to a head of the avatar, an image specific for the user corresponding to the avatar or the other users.

17. The information processing device according to claim 1, wherein the display control unit reflects display information related to the event on the avatars.

18. The information processing device according to claim 1, wherein if the number of avatars to be displayed on the terminal exceeds a predetermined number, the display control unit preferentially displays, from among the other avatars corresponding to the other users, the other avatars associated with the self-avatar corresponding to the user and displays the self-avatar and the other avatars such that the number of avatars to be displayed is within the predetermined number.

19. An information processing method causing an information processing device to:
display, on a terminal, a plurality of viewpoint images captured at different viewpoints in an event;
acquire avatar information about display of avatars corresponding to each of a user who is viewing the plurality of viewpoint images displayed on the terminal and other users who are viewing the plurality of viewpoint images on other terminals; and
control display of the avatars based on the avatar information, for the viewpoint images displayed on the terminal.

20. A program causing a computer to execute processing of:
displaying, on a terminal, a plurality of viewpoint images captured at different viewpoints in an event;
acquiring avatar information about display of avatars corresponding to each of a user who is viewing the plurality of viewpoint images displayed on the terminal and other users who are viewing the plurality of viewpoint images on other terminals; and
controlling display of the avatars based on the avatar information, for the viewpoint images displayed on the terminal.
